(19) United States
(12) Patent Application Publication
(10) Pub. No.: US 2014/0122152 A1
(43) Pub. Date: May 1, 2014

(54) System and Method for Matching Profiles without a Resume and Scheduling and Facilitating Web-Based Interviews

(71) Applicant: SkillShadow, LLC, Victoria, TX (US)

(72) Inventors: Grant M. Lee, Victoria, TX (US); VaShelle V. Lee, Victoria, TX (US); Gavin M. Lee, Victoria, TX (US)

(73) Assignee: SkillShadow, LLC, Victoria, TX (US)

(21) Appl. No.: 14/032,125

(22) Filed: Sep. 19, 2013

Related U.S. Application Data
(60) Provisional application No. 61/704,340, filed on Sep. 21, 2012.

(51) Int. Cl. G06Q 10/10

(52) U.S. Cl. CPC G06Q 10/1053; G06Q 10/1095
USPC 705/7.19

(57) ABSTRACT

A system and method for matching profiles without a resume and scheduling and facilitating web-based interviews is provided. Electronic process for real-time capture, matching, prioritization, and communication of data attributes, enhanced by embedded scheduling and facilitation of live personal interface between different classifications of users. The present invention has been particularly applied to the field of employment. The present invention seeks to render resumes obsolete by the capture, matching, prioritization, and communication of attributes of jobseekers and employers. The present invention further introduces the concept and embeds into the above process the convenient scheduling and facilitation of web-based interviewing.

This application claims priority to the following U.S. Provisional patent application which is incorporated by reference herein in its entirety: U.S. Provisional Patent Application No. 61/704,340, filed Sep. 21, 2012, entitled “System and Method for Matching Profiles without a Resume and Scheduling and Facilitating Web-Based Interviews.”

### TECHNICAL FIELD

The disclosed embodiments relate generally to systems and methods for matching profiles without a resume and scheduling and facilitating web-based interviews.

### BACKGROUND

Technology (including personal computers and the internet) has transformed the way data attributes about people and products are captured and stored. The present invention has been particularly applied to the field of employment. With the advent of the internet, the ability for employers to advertise their job openings migrated from newspaper print and word-of-mouth to on-line websites. Employers often publicize positions on their own company websites or pay significant fees to “post” their job openings on websites created just for such specialized purpose. Jobseekers scour such sites in hopes of identifying suitable positions to which to apply. It would be advantageous to provide systems and methods for matching personal profiles without a resume. Furthermore, it would be advantageous to provide systems and methods for facilitating web-based interviews between matching job seekers and employers.

### SUMMARY

Although technology has enhanced job search, there exists great potential for qualified jobseekers to fail to identify suitable, much less optimal, positions and there exists great potential for the most qualified applicant to be overlooked.

First, employers potentially incur substantial fees in placing limited term defined-duration job “postings” on job boards or in print media which, in both cases, present such “posting” unilaterally for potential viewing by candidates and manual jobseeker application. Second, a qualified jobseeker may not coincidentally be on-line searching that website during that posting duration. Third, in searching through a plethora of postings, a potential jobseeker may not recognize or identify that a particular job posting would be a good fit for their skills. Fourth, provided a jobseeker identifies a potential position, then they must begin the tasking process of applying and waiting. Fifth, in some cases employers require resumes to be uploaded, only to further require jobseekers to retype some or all parts of their skills into redundant questionnaires to glean the skills from the resume. Sixth, an employer must then manually review stacks of applicants in hopes of identifying qualified candidates. Seventh, the employer must then contact the selected candidates and arrange interviews, potentially at the cost of significant time and money for either party if distances are involved.

The current state of the art in employment involves jobseekers uploading their resumes (or curriculum vitae) in the hopes of being viewed by potential employers. Some websites have made considerable financial investments into “key word” searches to better identify skills in candidates' resumes. The current state of the art also includes use of social networking to bring together jobseekers with employers.

Resumes (or curriculum vitae) and interviews are a long-standing tradition or custom globally in the process of bringing together employers and jobseekers. The present invention utilizes technology to phase out resumes, eliminating the above mentioned drawbacks and limitations, and revolutionize job search and employment.

The present invention consists of a system and method for matching profiles without a resume and scheduling and facilitating web-based interviews. The present invention has been particularly applied to the field of employment.

The present invention consists of a website for jobseekers and employers which utilizes the present invention's unique process to match employers with qualified candidates. The present invention further provides a portal to schedule and facilitate web-based interviews.

The identification of qualified candidates for employment has been automated. The collection of skills data of jobseekers is user-friendly. The collection of open positions of employers is user-friendly. The matching of employers with jobseekers is entirely effortless and automated. The match is instantaneous. The notification to both parties is immediate.

A further user-friendly enhancement is that the jobseeker retains privacy and anonymity even through the matching process. The jobseeker retains control of whether and when to release his/her name and e-mail address (and any optional uploaded personal information) to a potential employer.

The attributes captured are comprehensive. The collection process eliminates typographical errors and facilitates automation through use of pull-down menu selections. Jobseekers have the option to save multiple profiles under a single username. Employers may access and track all of their open and matched positions (including in multiple languages across multiple geographic areas) in a single location on the website. In some embodiments, the matching jobseekers are provided to the employer in an automated prioritized presentation. In addition, the present invention provides employers multiple options to prioritize matched jobseekers (e.g., by such attributes as highest education, highest level of experience, or lowest requested pay), entirely at the discretion of the employer.

Once a jobseeker indicates interest in a position, the employer can immediately and directly schedule a web-based interview with the candidate. The scheduling process is automated, consisting of user-friendly pop-up calendar and clock functions, and keeps record of the schedule individually in both the employer's and jobseeker's accounts. As soon as a jobseeker confirms the web-based interview time slot, both parties are notified instantly. The employer initiates the interview on the very same webpage by clicking a single button.

The claimed invention solves each of the seven problems identified above. First, it improves the experience for employers. Instead of an employer perhaps paying for a defined-duration “job posting” unilaterally presented to jobseekers for potential viewing and manual application, the claimed invention automatically matches the attributes and contents of an employer's job entry to a pool of stored candidate profiles. (Note that the claimed invention does not preclude new candidates from viewing the employer's job entry, registering, creating a profile, and becoming matched to an employer's job entry ex post.) When a jobseeker creates a profile—whether ex ante or ex post creation of a particular employer's job entry—the present invention anonymously and automatically effectively submits such jobseeker's application to any and all such positions for which the jobseeker is qualified. Regardless of how the job entry input from an employer (equivalent to a job “posting”) is obtained—whether such input is obtained through the employer's direct input or through “scraping” or other indirect means—the present invention instantly matches the data captured from an employer to their targeted pool of candidates. (With regard to the present invention, “scraping” refers to the process whereby the contents of a job posting on an employer's website are automatically recognized, and stored, in a searchable format as described herein. In some embodiments, the “scraped” job entry is redisplayed on the present invention through no effort of the employer, following the employer's consent/account creation). Furthermore, the scraped job entry is compared to the current candidate pool such that the employer and each matched candidate would be automatically notified if there is a match.

Second, in some embodiments, the invention addresses the problem of the non-overlapping time frame of employer postings and jobseekers actively searching and finding that posting, comprehending that posting's suitability to their skills, and responding to that posting. Part of the invention's unique process lies in retaining jobseekers' skills in a constant repository available to be instantly matched to an employer's input. Provided there are no jobseekers who match the employer's requested attributes (pay level and experience associated with a set of skills in a particular location), the employer may easily adjust the attributes and/or the position will remain perpetually active (until selected for removal by the employer) awaiting a match from a new jobseeker entering the repository.

Third, in some embodiments, the invention assists jobseekers in finding positions that are an exact match for their skills and interests. The attributes captured include: location (country, state, local area), industry, specific area, position, experience, education, and pay. Plus the system provides for collection of optional information the jobseeker may wish for potential employers to see to distinguish among competing profiles. Thus the jobseeker's task of searching out a posted position which utilizes his or her skills and experience is performed automatically by the invention's unique process.

Fourth, in some embodiments, the invention automates the process of a jobseeker following up on a job posting for which he/she is qualified, thereby eliminating both the application burden and wait for response from the employer. The skills match is instantly conveyed to both the jobseeker and potential employer for action. The previously intensive process for the jobseeker has been simplified and automated. The user (both jobseeker and employer) has been made passive, with the invention utilizing the initial data capture to perform the search, identification, matching, application, prioritization, and communication on behalf of the jobseeker and the employer.

Fifth, in some embodiments, the invention eliminates the need for redundant and duplicative data entry by jobseekers solely to alleviate the employer's problem of filtering out unsuitable candidates. This provides time savings to the users. For employers who have required candidates to self-screen by responding to questionnaires on their own employer websites as part of the application process due to specific position requirements, certifications, licenses, or attributes, the present invention automates such screening. In some embodiments, the invention allows employers to indicate such specific requirements through either (a) the “additional information you would like the jobseeker to see” field, (b) the vast “content” text field, (c) the flexible “attachments” field, or most precisely (d) the “optional keywords” fields which require a candidate to exactly match the employer's criteria in order to be matched.

Sixth, in some embodiments the invention provides employers with only “prescreened” applicants, that is, candidates who have been filtered for attributes that meet the employer's criteria. The invention identifies and distinguishes candidates who have indicated interest in the employer's position from the pool of matched candidates. In response to a match, a candidate's election to forego anonymity in order to “indicate interest” in the position, by virtue of being a timely action in response to notification of being matched to an available position, ensures that interested candidate profiles are not “stale”. The present invention eliminates the chance that employers receive stacks of resumes or web-based profiles that are “dated” (i.e. submitted so long ago that the candidate is no longer an active candidate and is therefore a waste of the employers' time to consider).

Seventh, in some embodiments the claimed invention layers an additional benefit of providing embedded functionality for scheduling and facilitating web-based interviews between employers and qualified candidates as follow-on to the matching process. This provides an additional user-friendly time saving and cost saving capability. Of particular importance to some, in some embodiments the present invention combines convenience and “green” benefits by providing an all-in-one-place all-on-one-webpage ability for employers to find interested candidates, rank candidates with multiple criteria, track and sort candidates across multiple simultaneous openings without the need of printing and sorting through stacks of paper resumes. Furthermore, interviews can be scheduled (through as little as one click) and conducted utilizing web based live video chat applications. Thus the web based interviews save fuel that would have been required to transport the applicant to a physical interview site.

In addition, in some embodiments, the present invention as particularly applied to the field of employment permits users (both employer and jobseeker) to delete and then later restore previously deleted jobs and profiles. Deleted user entries are available for reuse in the user's account. This particularly assists employers who experience employee turnover or need to fill multiple similar positions in quickly and effortlessly republishing job entries that have been previously posted, filled, removed, and need to be filled again.

Furthermore, in some embodiments, the present invention does not require the use of personal information to perform the attribute collection, matching, prioritization, or communication process. In an age of identity theft, cyber insecurity, and focus on privacy policies, the process does not collect unnecessary personal attributes and does not need them to successfully provide results.

Overall, the unique process is designed to produce better quality results than the current convention of manual search of postings or social referral followed by resume transmittal and traditional interview. In certain embodiments, the invention contributes to productivity advances in job search and recruitment by (1) quicker employment match, (2) better skill match, (3) broader participation through convenience, (4) substantially lower cost in terms of both time and money, and (5) better resource use by encompassing “green” web-based interview technology in the comprehensive matching, sorting, ranking, and tracking mechanism.

### BRIEF DESCRIPTION OF THE DRAWINGS

For a better understanding of the aforementioned aspects of the invention as well as additional aspects and embodiments thereof, reference should be made to the Description of Embodiments below, in conjunction with the following drawings in which like reference numerals refer to corresponding parts throughout the figures.

FIG. 1 is a block diagram illustrating an exemplary distributed client-server system for matching profiles and facilitating web-based interviews in accordance with some embodiments of the invention.

FIG. 2 is a block diagram illustrating a server system for matching profiles and facilitating web-based interviews in accordance with some embodiments of the invention.

FIG. 3 is a flowchart representing a method of matching profiles without a resume and facilitating web-based interviews applied to the field of employment in accordance with some embodiments of the invention.

FIGS. 4A-4D are flowcharts for matching profiles and facilitating web-based interviews in accordance with some embodiments of the invention.

FIGS. 5-15B are schematic screen shots of exemplary graphical user interfaces for matching profiles and facilitating web-based interviews in accordance with some embodiments of the invention.

Like reference numerals refer to corresponding parts throughout the drawings.

### DESCRIPTION OF EMBODIMENTS

Reference will now be made in detail to embodiments, examples of which are illustrated in the accompanying drawings. In the following detailed description, numerous specific details are set forth in order to provide a thorough understanding of the present embodiments. However, it will be apparent to one of ordinary skill in the art that the present various embodiments may be practiced without these specific details. In other instances, well-known methods, procedures, components, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first element could be termed a second element, and, similarly, a second element could be termed a first element, without changing the meaning of the description, so long as all occurrences of the first element are renamed consistently and all occurrences of the second element are renamed consistently. The first element and the second element are both elements, but they are not the same element.

The terminology used in the description of the embodiments herein is for the purpose of describing particular embodiments only and is not intended to be limiting of the claims. As used in the description of the embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” as well as the terms “includes” and/or “including” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to,” depending on the context. Similarly, the phrase “if it is determined” or “if (a stated condition or event) is detected” may be construed to mean “upon determining” or “in response to determining” or “upon detecting (the stated condition or event)” or “in response to detecting (the stated condition or event),” depending on the context.

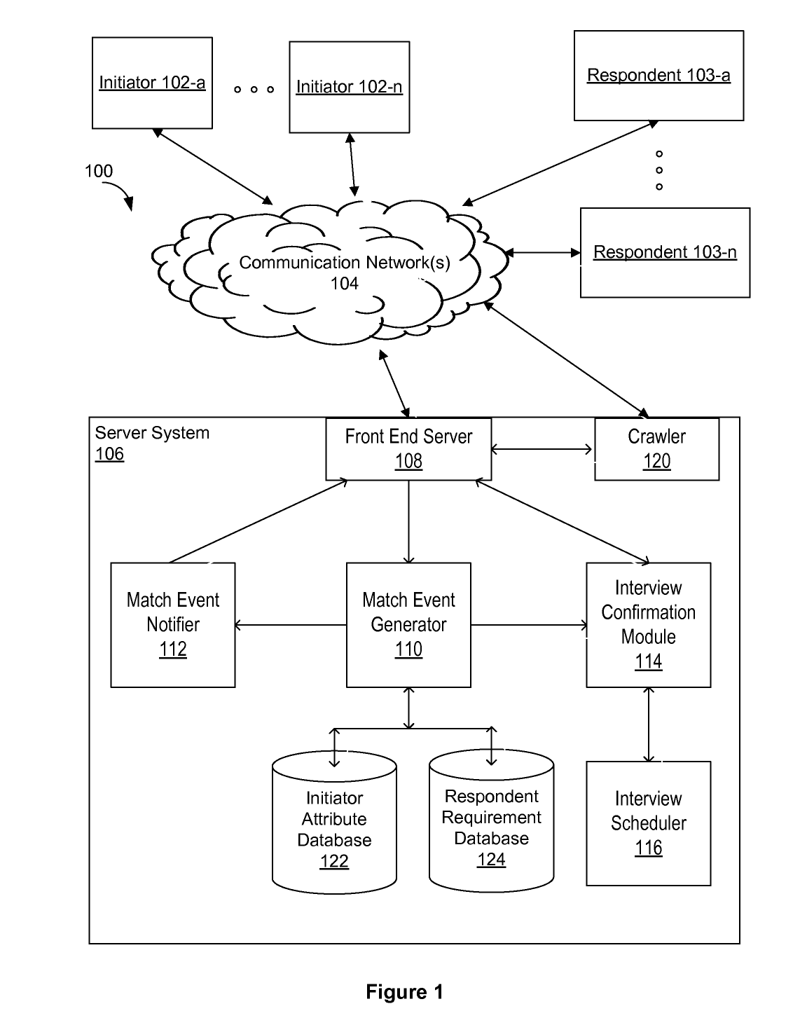

FIG. 1 Distributed Client-Server System 100 for Matching Profiles without a Resume

FIG. 1 includes a block diagram illustrating an example of a distributed client-server system 100 for matching profiles without a resume. System 100 includes one or more Initiator(s) 102 (e.g., Initiator 102-a, Initiator 102-n, and the like), one or more Respondents (e.g., Respondent 103-a, Respondent 103-n, and the like), a Server System 106 (also referred to herein as “Server 106”) and a Communication Network 104 for connecting Initiator(s) 102 to Server System 106, Respondent(s) 103 to Server System 106, and Initiator(s) 102 to Respondent(s) 103. Communication Network 104 optionally includes the Internet, one or more local area networks (LANs), one or more wide area networks (WANs), other types of networks, or a combination of such networks.

Initiator(s) 102 transmit(s) a plurality of attributes to Server System 106 through Communication Network 104. Respondent(s) 103 transmit(s) a plurality of requirements to Server System 106 through Communication Network 104.

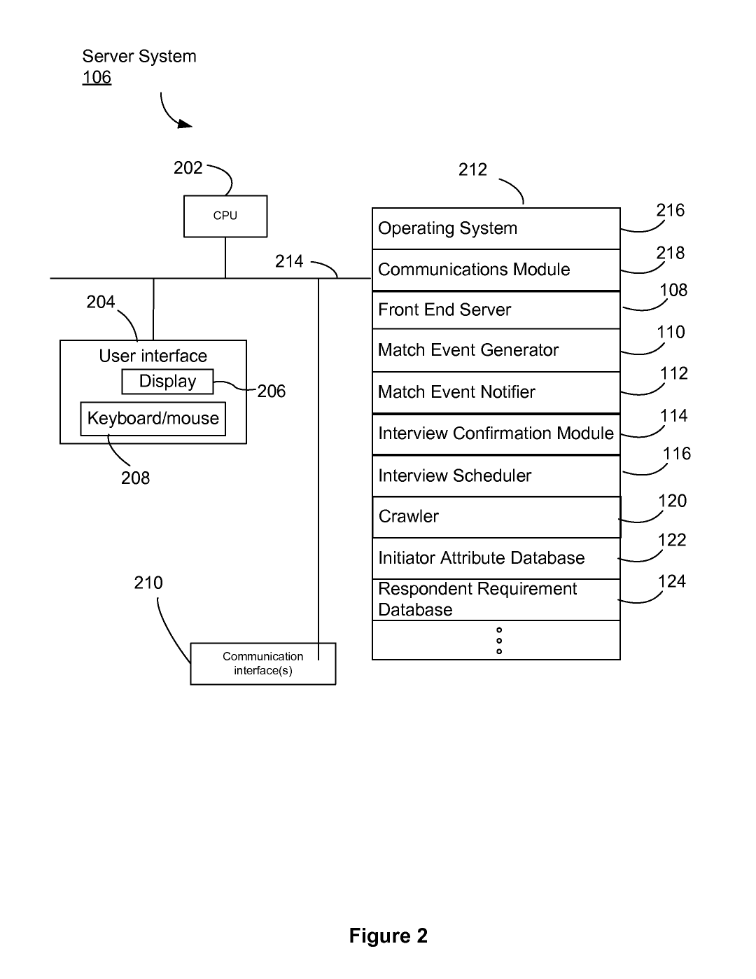

Server System 106 includes Front End Server 108, Match Event Generator 110, Match Event Notifier 112, Interview Confirmation Module 114, Interview Scheduler 116, a Crawler 120, an Initiator Attribute Database 122, and Respondent Requirement Database 124 (as described further in relation to FIG. 2).

FIG. 2 Server System 106 for Matching Profiles without a Resume

FIG. 2 includes a block diagram illustrating an example of a Server System 106 for matching profiles without a resume. Server System 106 typically includes one or more processing units CPU(s) 202, one or more network or other Communication Interfaces 210, Memory 212, a User Interface 204 comprising a display device 206 and a keyboard, mouse, touchpad, touch screen or other input device 208, and one or more Communication Buses 214 for interconnecting these components. Communication Buses 214 optionally include circuitry (sometimes called a chipset) that interconnects and controls communications between system components. Memory 212 typically includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. Memory 212 optionally includes one or more storage devices remotely located from the CPU(s) 202. Memory 212, or alternatively the non-volatile memory device(s) within Memory 212, comprises a non-transitory computer readable storage medium. In some embodiments, Memory 212 or alternatively the non-transitory computer readable storage medium stores the following programs, modules and data structures, or a subset thereof:

Operating System 216 that includes procedures for handling various basic system services and for performing hardware dependent tasks;

Communications Module (or instructions) 218 that is used for connecting Server System 106 to other computers (e.g., Initiator 102 or Respondent 103) via one or more Communication Buses 214 and Communication Interfaces 210 (wired or wireless) and one or more Communication Networks 104 (FIG. 1), such as the Internet, other wide area networks, local area networks, metropolitan area networks, and so on;

Front End Server 108 coordinates communication between Server System 106, Initiator(s) 102, Respondent(s) 103 and any other computer systems with which Server System 106 communicates. For example, Front End Server 108 receives a plurality of attributes from Initiator(s) 102 and a plurality of requirements from Respondent(s) 103, communicates a notification of a match-event to Initiator(s) 102 and/or Respondent(s) 103, communicates a confirmation of a web-based interview to Initiator(s) 102 and/or Respondent(s) 103;

Match Event Generator 110 compares the plurality of attributes associated with the Initiator(s) 102 and the plurality of requirements associated with Responder(s) 103 to generate a notification of a match-event;

Match Event Notifier 112 provides a bi-directional notification (e.g., notification to and/or acknowledgement from Initiator(s) 102 and to Respondent(s) 103) of the match-event to Initiator(s) 102 and to Respondent(s) 103. In some embodiments, Match Event Notifier 112 provides a bi-directional notification to the initiator (e.g., selected from Initiator(s) 102) and the respondent (e.g., selected from Respondent(s) 103) through Front End Server 108;

Interview Confirmation Module 114 provides a bi-directional confirmation of a web-based interview between the initiator and the respondent. To this end, Interview Confirmation Module 114 provides a finalized set of scheduling information (e.g., a date, a time, time zone) for the web-based interview between an initiator (e.g., selected from Initiator(s) 102) and a respondent (e.g., selected from Respondent(s) 103). In some embodiments, Interview Confirmation Module 114 provides a bi-directional notification to the initiator (e.g., selected from Initiator(s) 102) and the respondent (e.g., selected from Respondent(s) 103) through Front End Server 108;

Interview Scheduler 116 provides scheduling for the web-based interview between an initiator (e.g., selected from Initiator(s) 102) and a respondent (e.g., selected from Respondent(s) 103). Interview Scheduler 116 receives the finalized set of scheduling information from the Interview Confirmation Module 114. Interview Scheduler 116 makes a determination as to whether a current date and a current time match the finalized set of scheduling information. If a current date and a current time match the finalized set of scheduling information, then Interview Scheduler 116 initiates the web-based interview between the initiator (e.g., selected from Initiator(s) 102) and the respondent (e.g., selected from Respondent(s) 103). Accordingly, Interview Scheduler 116 provides a capability for web-based video conferencing between the initiator (e.g., selected from Initiator(s) 102) and the respondent (e.g., selected from Respondent(s) 103);

Crawler 120 utilizes the communications network(s) 104 to crawl a consenting respondents' postings (such as job postings) on external websites (e.g., the Respondent's website or an external job posting site where the respondent has posted an open job description) to “scrape” requirements associated with the respondent and automatically provide the requirements to the front end server 108, and in some embodiments the crawler 120 similarly scrapes consenting Initiator's attributes from an external website or public posting (e.g., a CV or profile displayed on a professional or social networking web service); and

Initiator Attribute Database 122 optionally stores the plurality of attributes associated with Initiator(s) 102 and Respondent Requirement Database 124 stores the plurality of requirements associated with Respondent(s) 103.

Each of the above identified elements is typically stored in one or more of the previously mentioned memory devices, and corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, Memory 212 stores a subset of the modules and data structures identified above. Furthermore, Memory 212 may store additional modules and data structures not described above.

Although FIG. 2 shows a server system 106, FIG. 2 is intended more as functional description of various features present in one or more servers than as a structural schematic of the embodiments described herein. In practice, and as recognized by those of ordinary skill in the art, items shown separately could be combined and some items could be separated. For example, some items shown separately in FIG. 2 could be combined. The actual number of servers or modules used to implement this server system 106 and how features are allocated among them will vary from one implementation to another, and typically depend in part on the amount of data and/or traffic from both Initiators and Respondents that the system must handle during peak usage periods as well as during average usage periods.

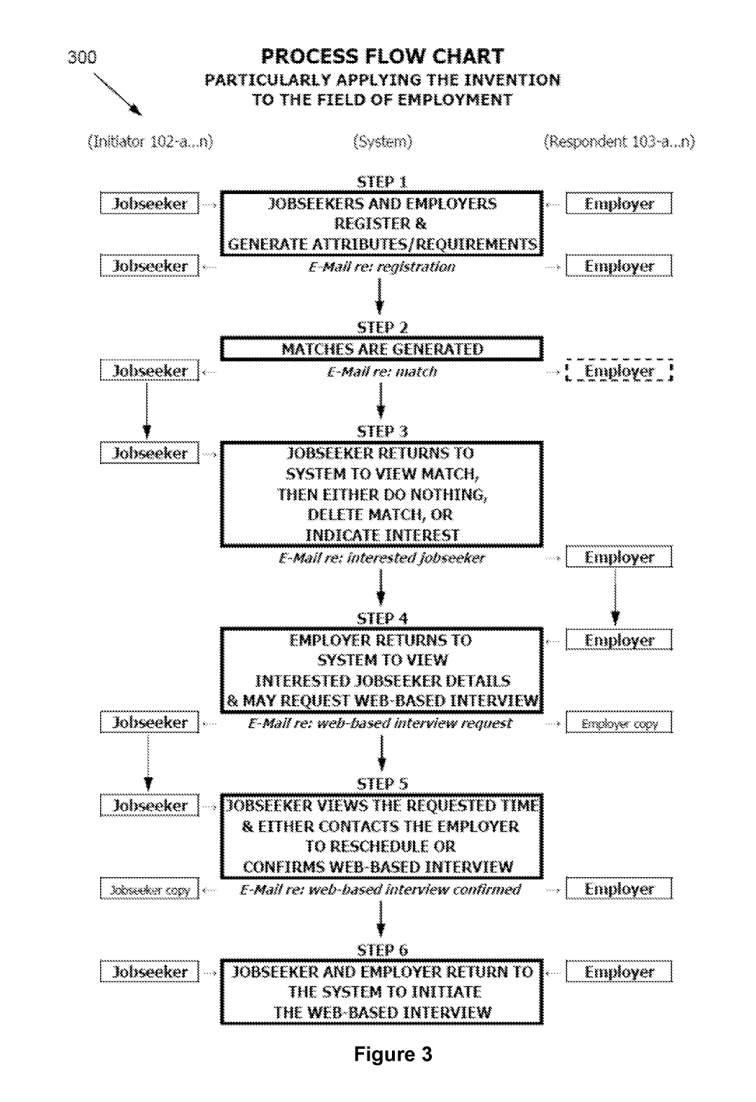

FIG. 3 Process Flow Chart Particularly Applying the Invention to the Field of Employment

FIG. 3 is a flowchart representing a server method 300 for matching profiles and facilitating web-based interviews, according to some embodiments. Server method 300 is typically governed by instructions that are stored in a computer readable storage medium and that are executed by one or more processors of one or more servers. Each of the operations shown in FIG. 3 typically corresponds to instructions stored in a computer memory or non-transitory computer readable storage medium. The computer readable storage medium typically includes a magnetic or optical disk storage device, solid state storage devices such as Flash memory, or other non-volatile memory device or devices. The computer readable instructions stored on the computer readable storage medium are in source code, assembly language code, object code, or other instruction format that is interpreted by one or more processors. Specifically many of the operations shown in FIG. 3 correspond to modules and components of the server system 106 shown in FIG. 2.

FIG. 3 particularly applies the invention to the field of employment. The process following the capture of attributes and showing the utilization of that data is outlined in a series of steps performed by the system. The drawing depicts the interface between the system and the users, specifically jobseekers and employers. As depicted in FIG. 3, the password protected website first collects and captures data attributes from different classifications of users, then matches, prioritizes, and communicates those attributes to the users. In the present invention, users are first classified by whether they are jobseekers or employers. An individual can register under both categories provided that user utilizes a unique e-mail address for each registration.

The data attributes collected and captured in Step 1 pertain to any combination of: location (country, state, local area), industry, specific area, position, experience, education, pay, and the like.

In some embodiments, users may select to view all attribute selections in the language of their choice. In other embodiments, the system provides a default language based on the users geographic location (determined via IP address, provided GPS information, or the like.) In some embodiments, users may elect to save their attribute selections (e.g., to Initiator Attribute Database 122 or Respondent Requirement Database 124 (see FIG. 1) for purposes of Match Event Generator 110) in a language other than their entry language.

In some embodiments, “Location (country)” allows users to make a selection from a pull-down menu from among all countries globally. In some embodiments, only countries where at least one employer has provided posting are initially provided to a jobseeker.

“Job location (state)” further allows users to make a selection from a pull-down menu from among states or provinces of the respective country. The options presented are dependent on the country selected above.

“Job location (city)” further allows users to specify a selection from a pull-down menu from among large cities, local area designations such as metropolitan regions, rural regions, or sectors. The options presented are dependent on the state selected above and may vary over time to reflect additional or reapportioned groupings resulting from demographic shifts or user request(s).

In some embodiments, a single open source global geography database is used to populate the three layer database for location. In some embodiments the database is refined based on user selections and/or suggested additions. In some embodiments, the most popular locations are presented in a visually distinctive manner or are provided in the selection list ordered according to the number of job postings provided by employers. Users may effectively select multiple locations by saving multiple entries.

“Industry” allows users to make a selection from a pull-down menu. In some embodiments, sixteen industry choices are provided. In some embodiments the industry choices are refined based on user selections and/or suggested additions. In some embodiments, the most industry choices are presented in a visually distinctive manner or are provided in the selection list ordered according to the number of job postings provided by employers.

“Specific area” allows user to make a selection from a pull-down menu to specify the exact job. The options presented are dependent on the industry selected above.

Industry and specific area are captured in a separate two layer database, which succinctly allows users to select a specific job from a comprehensive list of all possible jobs in a simple two-step process. In some embodiments, the Career Clusters and Occupation categories of the O-Net database are filtered for redundant classifications and used to create the content of this database. The user interface presently permits jobseekers to effectively pursue multiple jobs by saving multiple skills profiles under a single username. The system supports the active matching of all saved skills profiles.

“Position” allows the user to make a selection from a pull-down menu to indicate full-time, part-time, temporary, or contract status of the position.

“Optional Keywords” allows the user to select whether to input descriptive text.

“Experience” allows the user to make a selection from a pull-down menu indicating the years of experience attributable to the specific area selected above.

“Education” allows the user to make a selection from a pull-down menu to record the applicable education level.

“Hourly pay” allows the user to make a selection from a pull-down menu to indicate the desired pay level. In some embodiments, a currency converter plug-in is provided for the user's convenience.

Position, experience, education, and hourly pay are captured in additional databases. In some embodiments, all databases of the system use MySQL.

Additionally, in some embodiments users are provided a text box, (e.g., supported by K2 or the like) to allow user customization of the content of their profiles. The text box allows for keying in any information the user deems pertinent and/or upload of documents (e.g., jobseeker resumes or portfolios or employer job descriptions) if so desired. Once saved, the information is associated with that particular profile of the user, whether a particular skills profile of a jobseeker or a particular job entry of an employer.

In some embodiments, the invention also allows the user the option of linking his/her website or professional networking profile to the user's account. The user also can select whether the link will be visible in any or all profiles and/or job entries created.

Privacy restrictions built into the invention permit a jobseeker's skills profile to only be viewed by an employer in which the jobseeker has indicated interest. Jobseekers' profiles are never available for view by the public or other registered jobseekers on the website. In some embodiments, jobseekers' profiles are not available for view by even registered employers unless and until the jobseeker clicks a simple button to “indicate interest” in a specific employer with whom the jobseeker has been matched. This allows a user to search for jobs discreetly. For example, since the user has control to “indicate interest” the user can search for a new position without their current employer inadvertently receiving their information. Once a jobseeker indicates interest in a particular employer, the employer may then access all input and uploads of that jobseeker's profile(s).

In some embodiments, a jobseeker's profile(s) may be partially accessed and viewed by external parties with whom the jobseeker chooses to do “social sharing”. This functionality is included in the system as an “opt in” program. In some embodiments, the jobseeker can choose to do “social sharing” with all participating external parties, except for any external party specifically de-selected. One benefit of “social sharing” for the jobseeker is the ability for the jobseeker's partial profile to be seen immediately by the participating employers without delay.

Upon saving the user's selections (whether employer or jobseeker), the present invention's intelligent search function is triggered and immediately executes. The present invention's unique intelligent search engine (i.e., matching algorithm) identifies the attributes of users (e.g., jobseekers) that would meet or exceed the parameters of a different classification of user (e.g., employer).

In some embodiments, the matching algorithm first specifically searches criteria related to location, industry, and specific area. These require an exact match. The algorithm then detects whether the attribute related to experience of a jobseeker matches or exceeds the attribute specified by an employer. This is a covered match. The algorithm also detects whether the attribute related to education of a jobseeker matches or exceeds the parameter specified by an employer. Again, this is a covered match. The algorithm also detects whether the attribute related to pay matches or falls below the parameter specified by an employer. This is a covered match, as well, but in the inverse.

The matching algorithm optionally further detects keyword parameters input by an employer and/or jobseeker. The input of keywords is optional by both parties. The algorithm detects partial matches. In some embodiments, up to five (5) optional keywords may be input by employers on each job entry. In some embodiments, keywords input by employers require a partial or complete match by the jobseekers—wherein the number of required matching keywords is selected by the employer. This allows employers to refine the pool of matched job candidates. In some embodiments, up to seven (7) optional keywords may be input by jobseekers. Keywords input by jobseekers will be screened for match to employers. In some embodiments, the more matches detected the higher the jobseeker's priority in presentation to the employer. In contrast to employers, optional keywords input by jobseekers will assist with but never limit their match potential and will serve to provide additional data attributes to employers at the time of the match—prior to the jobseeker's indication of interest.

In step 2 of FIG. 3, the results of the matching algorithm (a match-event) are presented to both the employer and jobseeker. In some embodiments, the results are presented on-line to both parties and via e-mail alert to the jobseeker. The invention also provides for prioritization of match results (i.e., ranking of candidates) by the employer based on the employer's selection of ranking criteria, such as highest education, greatest experience level, or lowest requested pay. Taken together, the prioritization capability in conjunction with the intelligent search engine represents the prioritization and matching portions of the present invention, respectively.

In step 3 of FIG. 3, when a match is communicated to the users, it becomes the jobseeker's privilege and responsibility to indicate interest in the employer's position. In some embodiments, one classification of user continues to retain his or her privacy even after the match event has occurred and been communicated to both classifications of users. In some embodiments, the jobseeker will have access to the employer's contact details at this point, although the employer will not yet have personal and/or contact information for the jobseeker. The employer will be notified if and when a jobseeker indicates interest in the matched position. The employer will then, and only then, be provided with the jobseeker's name, e-mail address and other personal information. In some embodiments, at this point the employer is also provided access to the jobseeker's complete skill profile(s) which may contain additional uploaded information, including optional personal information, portfolios etc. In embodiments where the jobseeker has opted into “social sharing” the user's partial profile(s) may be accessed and viewed by the matching employer with whom the jobseeker chooses to do “social sharing” automatically. The rest of the complete user's profile is still only available after the jobseeker indicates interest in the matched position (e.g. the jobseekers' name and contact information is only provided to the employer after the jobseeker indicates interest in the matched position and the jobseeker remains “anonymous” during the initial stages of “social sharing”.)

In step 4 of FIG. 3, now that the employer has been matched to a jobseeker that has confirmed interest in the position, the employer may return to the same webpage where the match is presented to now see the jobseeker's contact details (name and e-mail address, with link to e-mail directly within the system). The employer will also be able to click a simple link to view the jobseeker's profile(s). In some embodiments, the employer is also sent an email alert with the user's contact information and/or a link to the jobseeker's profile.

Importantly, at the time the jobseeker indicates interest in the employer, the present invention will trigger a scheduling function to appear in the employer's match list under that particular jobseeker's listing. The employer will be presented with calendar and clock pop-up menus from which to select a time slot for a web-based interview. The employer has his choice of interview duration and the employer may schedule and conduct as many web-based interviews with candidates as desired. The present invention allows employers to sort their matched candidate display by confirmed interview schedule, unconfirmed interview requests, and latest update and/or change. In some embodiments, if the employer schedules an interview for less than 10 minutes, a warning/notification message will appear notifying the employer of the unusually short duration of the interview and asking for confirmation that the duration is intentionally short. In some embodiments, the present invention will display all requested and confirmed interview schedules for all positions of an employer on one webpage. In other embodiments, each position's interviews are presented separately. In still other embodiments, the employer can sort the interviews by the employee scheduled to take the interview to easily confirm that the same employee is not double scheduled. The present invention further includes on that one webpage the ability to sort, rank, and track matched candidates and/or web-based interviews by job opening, and further by interview scheduling status, such as requested, confirmed, or in progress.

In step 5 of FIG. 3, the present invention will present the jobseeker with the ability to confirm the web-based interview. In some embodiments, a button is provided for the jobseeker to perform “single click confirmation” of the web-based interview date/time slot. Upon confirmation, the present invention will update the employer's match list to reflect the confirmed interview time and generate an e-mail to the employer to notify him/her of the confirmation.

It is further noted that when an employer requests a web-based interview, the jobseeker does not have to be on the system. In some embodiments, the jobseeker will be sent an e-mail indicating that a web-based interview has been requested. In some embodiments, for security purposes no personal information is shared by e-mail. When the jobseeker returns to the password protected website, he/she will find the web-based interview request has appeared on his/her match list along with the matched position description. If the time slot requested is unsuitable, the jobseeker can contact the employer with the contact information presented on the website and the employer may suggest a new date and/or time to reschedule the interview. In some other embodiments, the jobseeker can suggest a revised time/date for the web-based interview to the employer on the website, and the suggested revised time will be automatically provided to the employer. In yet other embodiments, the employer provides the job seeker with a plurality of potential web-based interview slots, and allows the user to confirm the interview by selecting one of the provided interview slots. Rescheduling by either the employer or the jobseeker is as easy as the initial scheduling process consisting of pop-up menus and a single button click to request the web-based interview time slot.

In step 6 of FIG. 3, the web-based interview is initiated. Another benefit of the present invention is that when the beginning time of the web-based interview time slot arrives, a single button will appear in the employer's match list below that particular jobseeker's match. In the present invention, with a single click, the employer will initiate a peer-to-peer live video chat web-based interview (such as Skype or the like). The clickable button appears directly in the employer's match list webpage and is visible during the entire scheduled time slot duration, until clicked by the employer. In the event of an unexpected disconnection of the web-based interview, the employer will be able to click the button again to restart the interview. The employer may initiate other interviews from the same webpage. The employer can even initiate a multiple party interview, including for example, a panel of interviewers to “team interview” the jobseeker. It is also noted that in some embodiments the system allows an employer to simultaneously and separately interview two candidates via two different employer computer terminals.

The present invention represents a significant step change from the present state of the art in job search and recruitment. The present invention transforms and automates the process for jobseekers versus job search using the present state-of-the art technology in on-line job posting websites, thus enhancing the chance of successful and targeted match of a jobseeker's skills to available positions. The present invention performs the search on behalf of the user (jobseeker or employer) and communicates the results to the user. The jobseeker need not upload a resume and the employer need not read it. Technology is employed to render resumes obsolete. The present invention further enhances the employer experience by automatically presenting the employer with all qualified and actively interested candidates. In addition, the employer is presented with a convenient tool to schedule and conduct interviews directly with an interested jobseeker through the same portal.

The present invention is significantly different from the services offered by social networking in job search and recruitment, in that the process functions up through the point of a jobseeker being matched to an available position without sharing of a jobseeker's personal information. Thus the job searching is both automated and discreet.

It is noted that the present invention combines convenience and “green” benefits by providing an all-in-one-place all-on-one-webpage ability for employers to find interested candidates, rank candidates with multiple criteria, track and sort candidates across multiple simultaneous openings without the need of printing and sorting through stacks of paper resumes. Furthermore, interviews can be scheduled (through as little as one click) and conducted utilizing web-based live video chat applications. Thus the web based interviews save fuel that would have been required to transport the applicant to a physical interview site.

The present invention's embedded scheduling and facilitation of live personal interface between users (i.e., the web-based interview) represents a cost-saving, “green”, and user-friendly enhancement that introduces the necessary social aspect to the employment process, without the need for networking.

In summary, the present invention collects and captures data attributes of different classifications of users (step 1). The present invention then triggers an intelligent search function with tiered matching criteria applied across the multiple databases, executing (1) strict matches, (2) covered matches, and (3) partial matches depending upon the attribute (step 2). When multiple results are generated (for example, when multiple jobseekers are a match for an employer's new job entry), the present invention provides the mechanisms to prioritize the results based on criteria selected by the user. Throughout the process, the present invention communicates with the users uniquely based upon their classification. The system updates each user's password protected webpage and also generates e-mail notifications. The process informs and notifies users back and forth of actions by a user in another classification (FIG. 3, steps 3 through 5). The process also has privacy settings dependent upon the user's classification. The present invention then offers an embedded means for users to request, communicate, schedule, confirm and initiate live personal interface between different classifications of users (e.g., web-based interview).

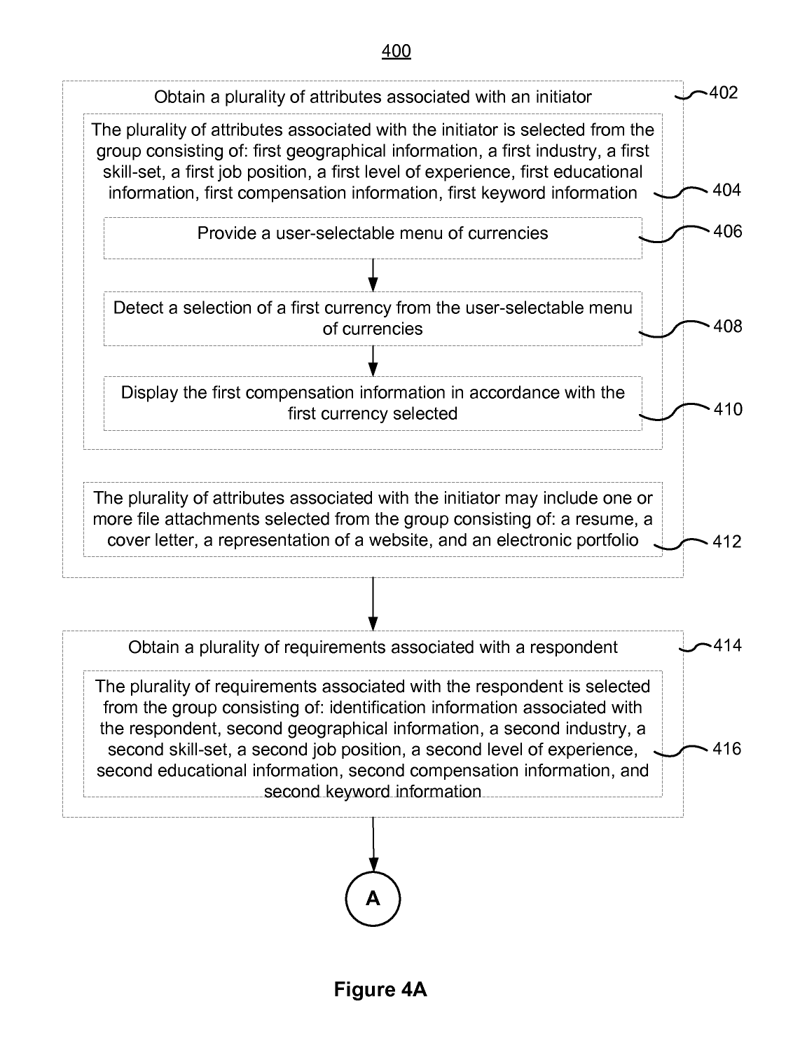

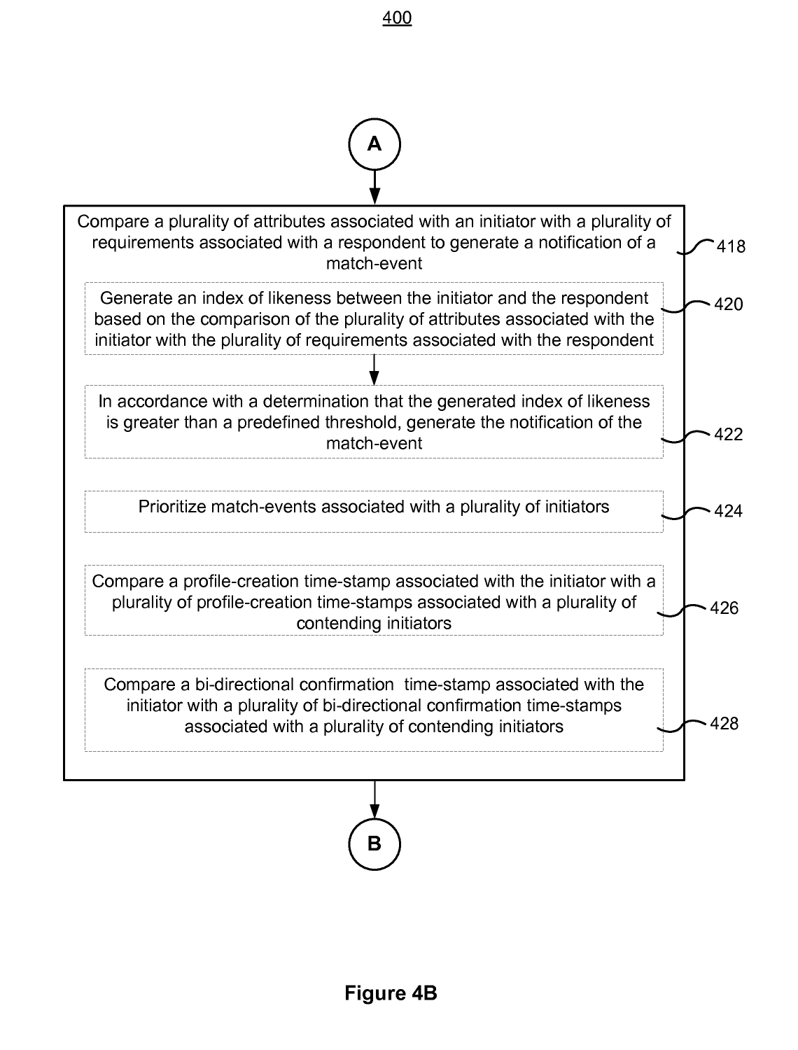

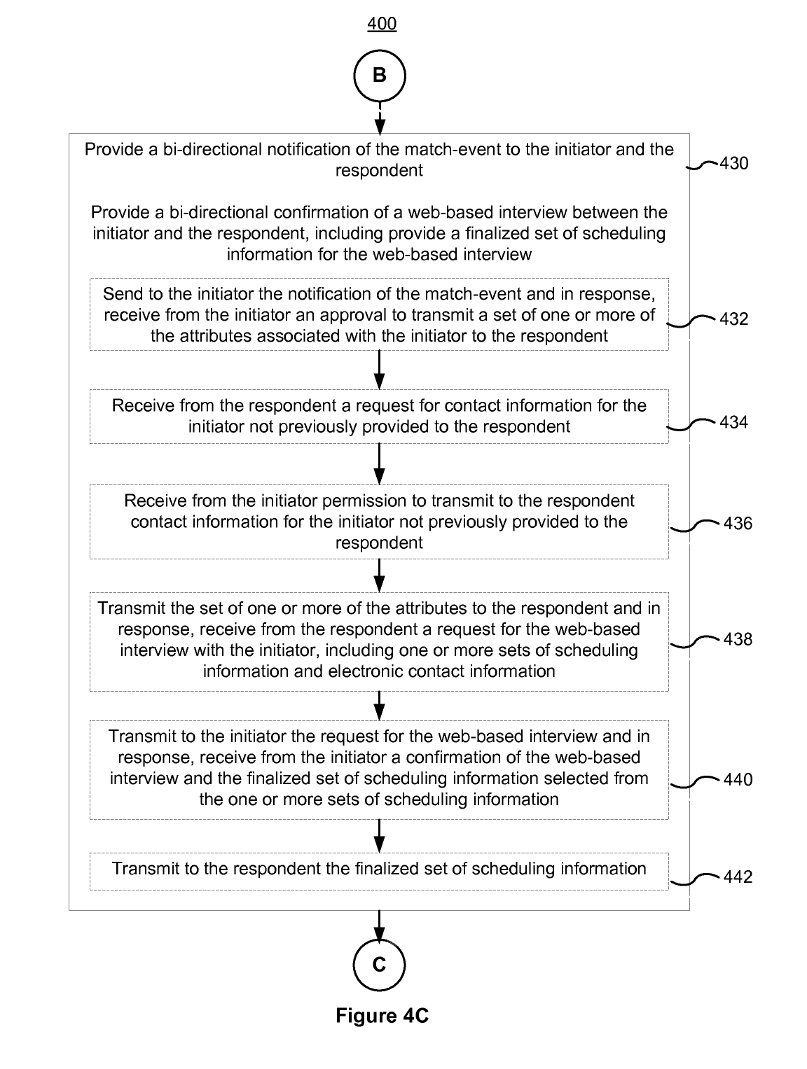

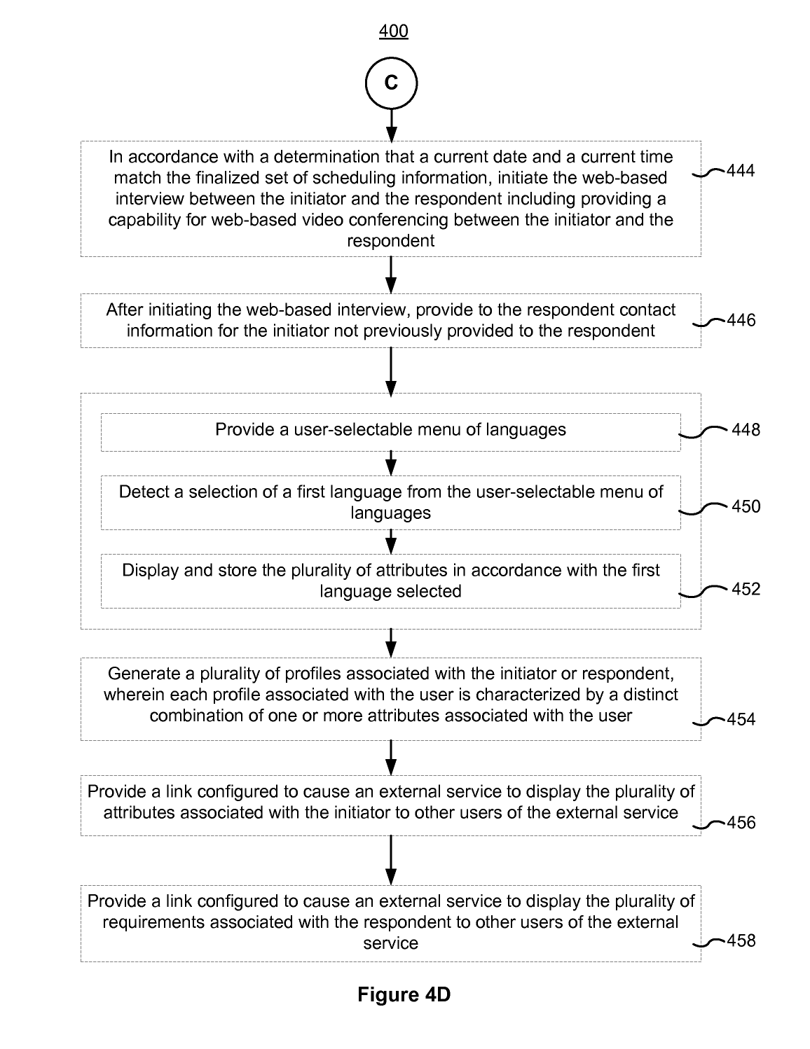

FIGS. 4A-4D Flowchart of Method 400 for Matching Profiles without a Resume

FIGS. 4A-4D include a flowchart representing a method 400 for matching profiles without a resume, according to certain embodiments. Method 400 is, optionally, governed by instructions that are stored in a non-transitory computer readable storage medium and that are executed by one or more processors of one or more servers (e.g., Server 106, FIG. 2). Each of the operations shown in FIGS. 4A-4D typically corresponds to instructions stored in a computer memory or non-transitory computer readable storage medium (e.g., Memory 212 of Server 106 in FIG. 2). The computer readable storage medium may include a magnetic or optical disk storage device, solid state storage devices such as Flash memory, or other non-volatile memory device or devices. The computer readable instructions stored on the computer readable storage medium may include one or more of: source code, assembly language code, object code, or other instruction format that is interpreted by one or more processors. In various embodiments, some operations in method 400 may be combined and/or the order of some operations may be changed from the order shown in FIGS. 4A-4D.

As shown in the detailed steps illustrated in FIGS. 4A-4D, in some embodiments the method for matching profiles without a resume is performed as follows. It is noted that although this application describes matching profiles for a job search in detail, in other embodiments matching profiles is used for dating, mentoring, collegiate and other educational acceptance, volunteer opportunities, medical services provision, financial services provision, political association, sports association, real estate, and other similar profile matching instances.

As shown in FIG. 4A, the process (400) of matching profiles and facilitating web-based interviews in accordance with some embodiments is performed as follows.

A plurality of attributes associated with one or more initiators are obtained (402). In various embodiments these attributes are inputted, selected by pull down menus, or scraped as described above. The plurality of attributes associated with the initiator is selected from the group consisting of: first geographical information, a first industry, a first skill-set, a first job position, a first level of experience, first educational information, first compensation information, and first keyword information (404).

In some embodiments, a user-selectable menu of currencies is provided (406). A selection of a first currency from the user-selectable menu of currencies is detected (408). Then first compensation information in accordance with the first currency selected is displayed (410).

In some embodiments, the plurality of attributes associated with the initiator may include one or more file attachments (412). Examples of file attachments include: a resume, a cover letter, a representation of a website, and an electronic portfolio. It is noted that the file attachments do not influence the matching described below.

A plurality of requirements associated with one or more respondents are also obtained (414). It is noted that the plurality of requirements associated with the respondent can be obtained before or after obtaining the attributes associated with the initiator. In some embodiments, the plurality of requirements associated with the respondent is selected from the group consisting of: identification information associated with the respondent, second geographical information, a second industry, a second skill-set, a second job position, a second level of experience, second educational information, second compensation information, and second keyword information (416).

FIG. 4B illustrates the process (400) continuing. A plurality of the attributes associated with an initiator is compared with a plurality of the requirements associated with a respondent to generate a notification of a match-event (418). Specifically, in some embodiments, an index of likeness between the initiator and the respondent is generated based on the comparison of the plurality of attributes associated with the initiator with the plurality of requirements associated with the respondent (420). In some embodiments, some attributes/requirements are weighted higher than others in generating the index of likeness having a weighted comparison.

A notification of the match-event is generated when the generated index of likeness is determined to be greater than a predefined threshold (422). Match-events associated with a plurality of initiators are then prioritized (424). The prioritization is performed in accordance with various prioritizations described in this specification.

In some embodiments, a profile-creation time-stamp associated with the initiator is optionally compared with a plurality of profile-creation time-stamps associated with a plurality of contending initiators (426). Furthermore, in some embodiments, a bi-directional confirmation time-stamp associated with the initiator is optionally compared with a plurality of bi-directional confirmation time-stamps associated with a plurality of contending initiators (428).

FIG. 4C illustrates the process (400) continuing. A bi-directional notification of the match-event is provided to the initiator and the respondent (430). Furthermore, a bi-directional confirmation of a web-based interview between the initiator and the respondent is provided, which includes a finalized set of scheduling information for the web-based interview (430).

Specifically, a notification of the match-event is sent to the initiator, and in response, the initiator approves the system to transmit a set of one or more of the attributes associated with the initiator to the respondent (432). In some embodiments, this approval is set up to be automatic if the initiator has opted into a “social sharing” function.

It is noted that in some embodiments, contact information is not initially provided to the respondent. As such, the respondent may provide a request for contact information for the initiator (434). A request for the information is sent to the initiator. The initiator then provides permission to transmit his/her contact information to the respondent (436).

In some embodiments, after the set of one or more of the attributes is transmitted to the respondent, the respondent requests a web-based interview with the initiator (438). The respondent can request the web-based interview regardless of whether they have requested or already received contact information for the initiator. The web-based interview request includes one or more sets of scheduling information and electronic contact information for the respondent.

The system transmits the request for the web-based interview to the initiator (440). Then in response, initiator provides a confirmation of the web-based interview. The confirmation includes finalized set of scheduling information selected from the one or more sets of scheduling information provided by the respondent. Then the finalized set of scheduling information is transmitted to the respondent (442).

FIG. 4D illustrates the process (400) continuing.

In accordance with a determination that a current date and a current time match the finalized set of scheduling information, the web-based interview between the initiator and the respondent is initiated (444). The initiation of the web-based interview includes providing a capability for web-based video conferencing between the initiator and the respondent.

In some embodiments, after initiating the web-based interview, the system provides to the respondent contact information for the initiator not previously provided to the respondent (446).

It is noted that throughout the process various webpage displays provide the following options to any user (initiator, respondent, or other user): A user-selectable menu of languages is provided (448). A selection of a first language from the user-selectable menu of languages is detected (450). Furthermore, the display is then updated in accordance with the selection. Furthermore, the plurality of attributes/requirements in accordance with the first language selected are also displayed and stored as appropriate (452). In some embodiments, the plurality of attributes/requirements from users may be input in a first language prior to a user's selection of a second language (translation) prior to storage of the attributes/requirements, rather than input the attributes/requirements in a second language. Additionally, in some embodiments, a user may enter an additional plurality of attributes/requirements in a first language and then select a third or fourth, etc. language (translation to yet another language) prior to storage for this set of attributes/requirements. The attributes/requirements will be stored in the language selected at time of submission to the system. For example, a single user (a global employer) may store multiple pluralities of attributes/requirements (all of their global job openings) in multiple languages under a single user account.

In some embodiments, step 402 can be augmented as follows. A plurality of profiles/requirements associated with the user (initiator or respondent) is generated by the user (initiator or respondent) (454). Each profile associated with the user (initiator or respondent) is characterized by a distinct combination of one or more attributes associated with the user (initiator or respondent).

In some embodiments, a link is provided, wherein the link is configured to cause an external service to display the plurality of attributes associated with the initiator (or an associate initiator profile) to other users of the external service (456).

In some embodiments, step 414 can be augmented as follows. A plurality of requirements (job entries) associated with the respondent are generated by the respondent. Each profile (job entry) associated with the respondent is characterized by a distinct combination of one or more attributes associated with the initiator. In some embodiments, each set of a plurality of attributes generated by a user (i.e., a profile/job entry) is assigned a unique tracking number by the system.

Similarly, in some embodiments a link is provided, wherein the link is configured to cause an external service to display the plurality of requirements associated with the respondent (or an associated Job entry) to other users of the external service (458).

To summarize, in some embodiments, a plurality of attributes associated with an initiator (e.g., job seeker) is compared with a plurality of requirements associated with a respondent (e.g., job provider) to generate a notification of a match-event. A bi-directional notification of the match-event is provided to the initiator and to the respondent. In some embodiments, the bi-directional notification includes a notification to and or an acknowledgement from the initiator and respondent. Then a bi-directional confirmation of a web-based interview between the initiator and the respondent is provided. In most embodiments, providing the bi-directional confirmation of the web-based interview includes providing a finalized set of scheduling information (e.g., a date, a time, time zone) for the web-based interview. When it is determined that a current date and a current time match the finalized set of scheduling information, the web-based interview is initiated between the initiator and the respondent. Initiating the web-based interview includes providing a capability for web-based video conferencing between the initiator and the respondent.

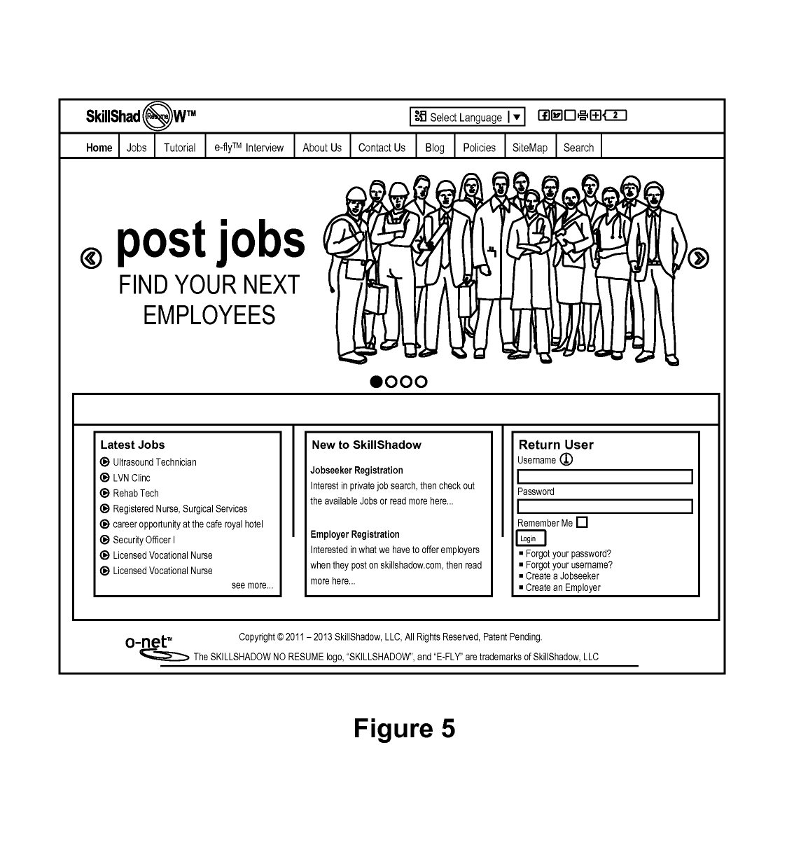

FIGS. 5-15B Screen Shots of Exemplary Embodiments

FIGS. 5-15B are schematic screen shots of exemplary graphical user interfaces for matching profiles and facilitating web-based interviews in accordance with some embodiments of the invention. It is noted that these figures illustrate graphical user interfaces utilized by an exemplary website that provides the service of matching jobseeker profiles with open employer positions, and facilitating web-based interviews between employers and jobseekers. However, as noted above, other embodiments may match profiles and facilitate web-based interviews for dating, mentoring, collegiate and other educational acceptance, volunteer opportunities, medical services provision, financial services provision, political association, sports association, real estate, and other similar profile matching and interview instances. One of skill in the art could interpret elements of the exemplary screen shots below in the context of another embodiment.

FIG. 5 Screen Shot of skillshadow.com Home Page

FIG. 5 particularly applies the invention to the field of employment. This is the landing point for the skillshadow.com website. The figure depicts the entry point for different classifications of users, particularly jobseekers and employers, to click the appropriate button to register and access the full services and capabilities of the website.

For starters, users may select the language in which they would prefer to view the entire site (as explained in more detail with respect to FIG. 3, step 1 and FIG. 4D, steps 448, 450, and 452). Registered users may proceed directly to login from this page. Registered users may also receive login assistance from this page for a forgotten password and/or username.

The tabs shown on FIG. 5 allow users, both registered and unregistered, to visit other areas of the website. From this page, both registered and unregistered users may click to view a listing of Jobs. Registered and unregistered users may click to view a description and information for first time users of an E-Fly™ interview, skillshadow.com's web-based interview system. Both registered and unregistered users may contact the skillshadow.com administrators by clicking the “Contact Us” button. The landing page is also the place to click to learn “About Us” and to access the site's Policies (Privacy and Terms and Conditions of use). Importantly, from this landing page, jobseekers and employers can launch a Tutorial, containing specifics of how the site operates and how to best use it. The site also contains a Blog with relevant content. In addition, the site contains a “Search” tab which allows the open Jobs to be searched based on location, industry, or position.

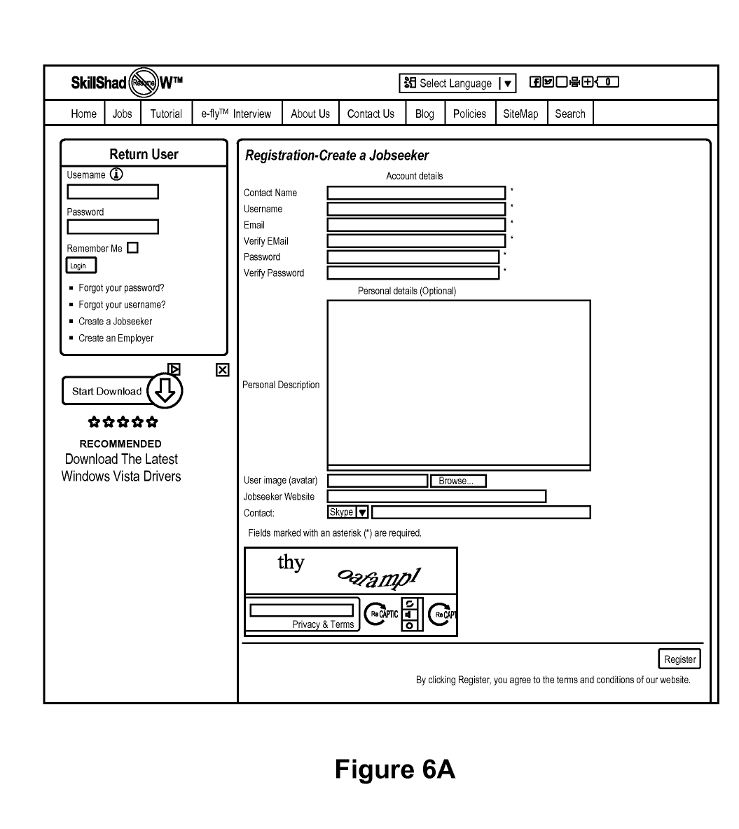

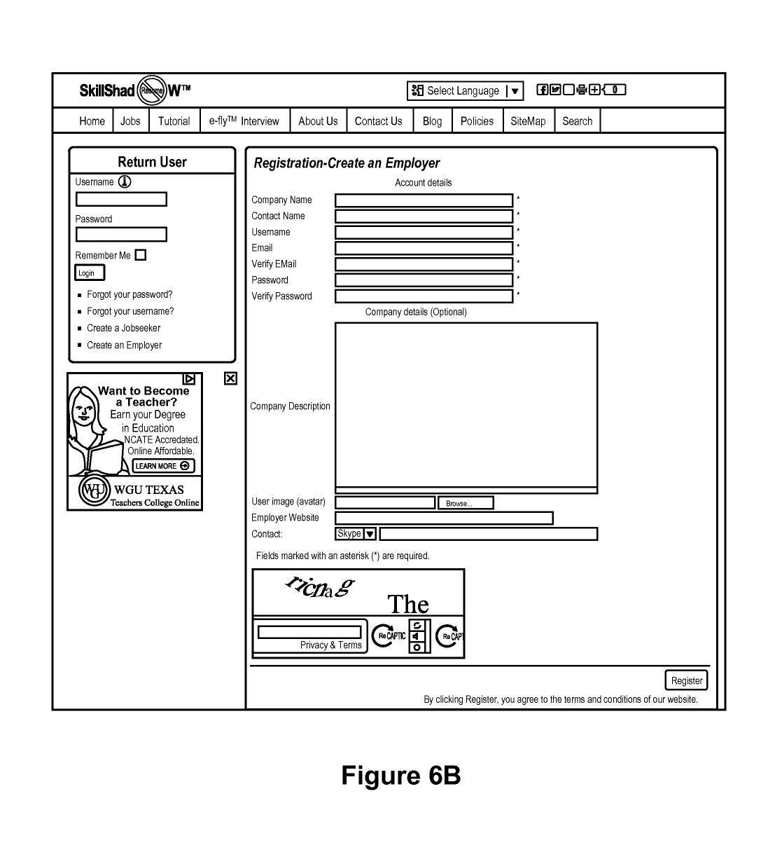

FIGS. 6A-6B Screen Shots of skillshadow.com Jobseeker and Employer Registration Pages

FIGS. 6A and 6B particularly apply the invention to the field of employment. These are the Jobseeker and Employer Registration pages for the skillshadow.com website. The primary focus is to complete the single page registration process. As illustrated in FIG. 6A, the information required of a jobseeker to register is simply a unique username and password in addition to their name and an e-mail address. In some embodiments, this user information will be kept private until the jobseeker opts to disclose it. The jobseeker may optionally include additional information, including personal photos, avatars, or text input, plus the jobseeker's website and on-line video chat (e.g. Skype) contact details. The jobseeker may review the Terms and Conditions of the website on the Policies page prior to completing the one-page registration. Upon completing the required spam blocker security input, the jobseeker user simply clicks the Register button to complete the process.

As illustrated in FIG. 6B, the information required of an employer to register on skillshadow.com additionally includes the employer's company name and the hiring contact's name in addition to a selected username and password to accompany the e-mail address with which the employer has chosen to register. On the Employer Registration page, employers may optionally provide a detailed employer description including company logo, select an avatar, link to the employer's website, and input the employer's contact information. This page allows the employer to input an on line video chat (e.g. Skype) account name the user wishes to use to conduct E-Fly™ interviews. The employer may review the Terms and Conditions of the website by clicking the Policies navigation tab prior to completing registration. Upon completing the required spam blocker security input, the employer user simply clicks the Register button to complete the process.

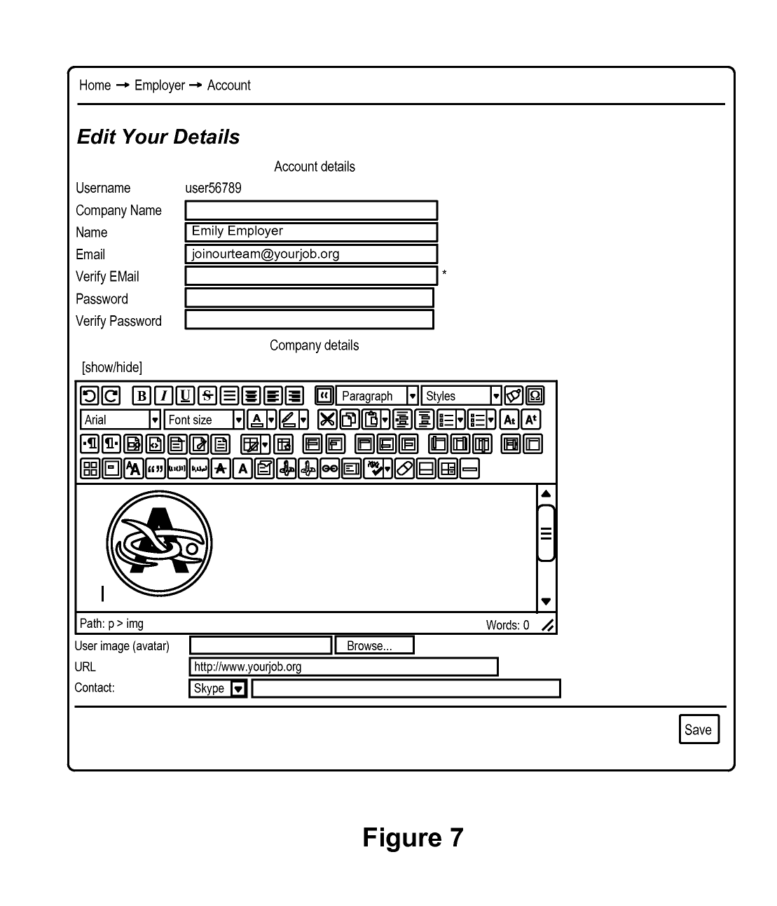

FIG. 7 Screen Shot of skillshadow.com Account Page

FIG. 7 particularly applies the invention to the field of employment. Once registration is complete, registered users may now navigate through all of the menu items available to registered users, including editing their account details on the Account page. This page invites a user (Jobseeker or Employer) to—“Edit Your Details” for the skillshadow.com website. FIG. 7 illustrates the Employer page but a Jobseeker page is functionally equivalent. The employer may modify the way the company name is listed and change the employer's hiring contact. Additionally, the registered employer or jobseeker user may update the e-mail address and password for their account on this page. The page further allows the user to modify the other registration inputs (from FIG. 6A or 6B), such as description, avatar selection, website URL link, and on-line video chat contact information.

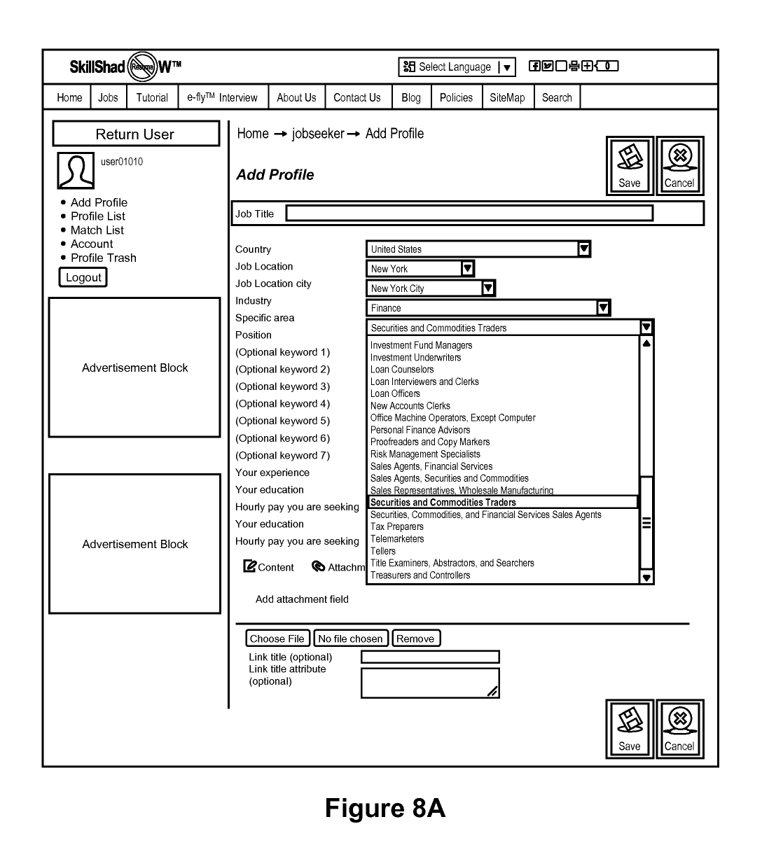

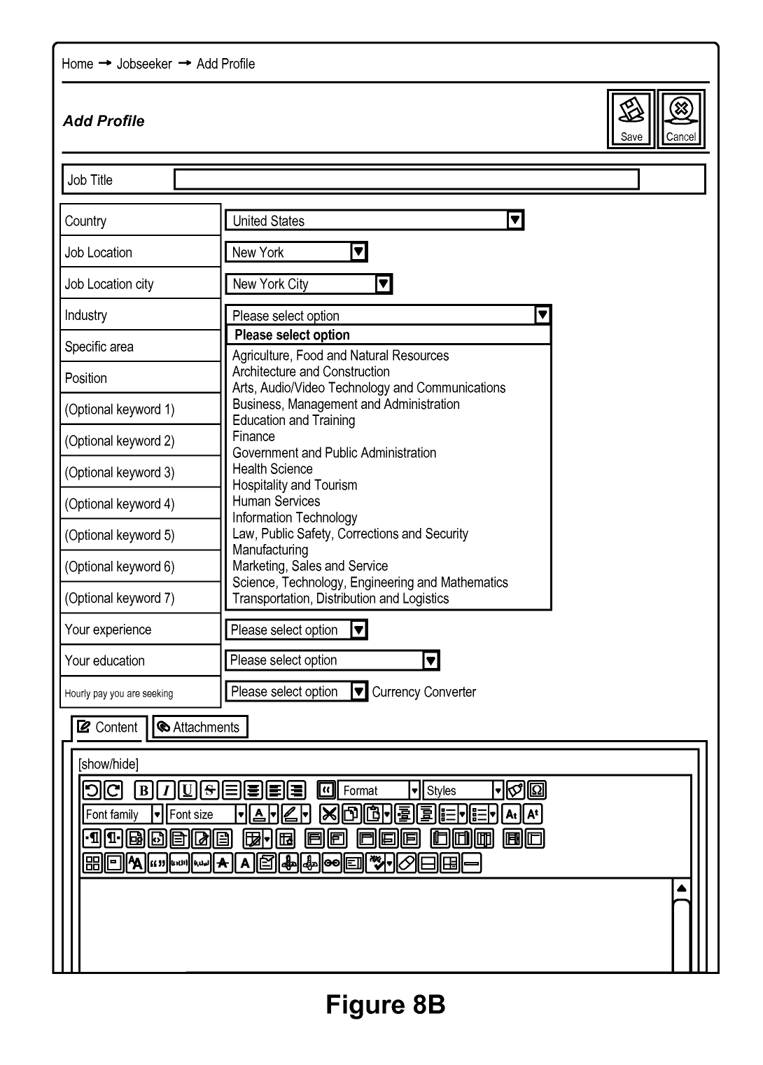

FIGS. 8A-8B Screen Shots of skillshadow.com Add Profile Page

FIGS. 8A-8B particularly apply the invention to the field of employment. This is the single Jobseeker—Add Profile page for the skillshadow.com website shown in alternate views. Jobseekers may navigate around the website from this page (as more fully described under FIG. 5) and may select or change the language in which they would prefer to view the entire site or simply this page. The jobseeker may navigate through the password-protected areas for a registered jobseeker, such as: Add Profile, Profile List, Match List, Account and Profile Trash through the left navigation menu. The primary focus of this page is to allow a jobseeker to create a profile.

As illustrated in FIGS. 8A and 8B, the user-friendly profile data collection is (1) performed on a single input page and (2) consists almost entirely of pull-down menus for all required data attributes (e.g. no resume upload is required). A jobseeker must select or input a title for each profile. Titles are used for reference in system communications with the jobseeker and for sorting purposes in the jobseeker's Match List. Data attributes collected on this page are used for comparing attributes with a different classification of user (i.e., with an employer) and reporting a match when such occurs.

In some embodiments, the information collected in FIG. 8A or alternately FIG. 8B includes location (e.g., a selection of 271 countries, associated state or province, and city or geographical region), the industry and specific area of the industry (e.g., Finance could be selected from the industry choices and Securities and Commodities Traders could then be selected from the specific area choices), the position (e.g., full time, part time, temporary, or contract), experience in this field (e.g., none, 1 year, 2 years, 3-5 years, 6-10 years, 11-15 years, or above 15 years), the jobseeker's education (e.g., none, high school or equivalent, military training, associates or vocational degree, bachelors degree, masters degree, doctorate, or professional), and the hourly pay requested (e.g., below $10/hour, $10-$15/hour, $15-$20/hour, $20-$30/hour, $30-$40/hour, or above $40/hour). The hourly pay is depicted in US dollars; however, a currency converter link is included to allow for conversion to the user's selected currency. More details regarding these selections are described with respect to FIG. 3.

In some embodiments, this webpage allows the jobseeker to optionally include up to seven (7) keywords to provide additional profile differentiation. Keywords input by a jobseeker convey additional information about a jobseeker and serve to enhance a jobseeker's match to a position where the employer has specified required keyword skills. The matching criteria for keywords are described in detail under FIG. 3 above. Keywords input by a jobseeker never limit the jobseeker's matches to available Jobs. Additionally, in some embodiments, this webpage permits but does not require the jobseeker to include up to five hundred (500) characters of additional information the jobseeker wishes the other classification of user (the matched employer, in this case) to see, as illustrated in FIG. 8B. The jobseeker also has a second convenient input box to optionally upload the jobseeker's portfolio, significant transactions list, resume, or any other desired information, as illustrated at the bottom of FIG. 8A. This input box allows the jobseeker to both input information on-line and to conveniently attach files which will become part of this profile. Optional additional information input by the jobseeker is not used in the matching process and will not limit a jobseeker's matches to available Jobs for which the jobseeker is potentially qualified.

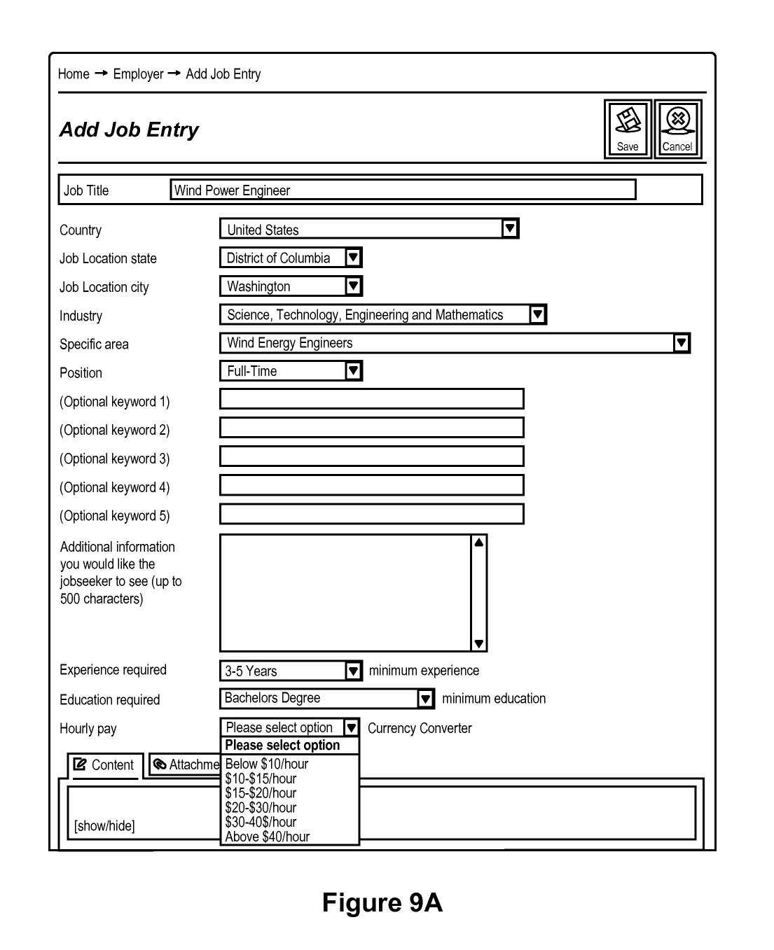

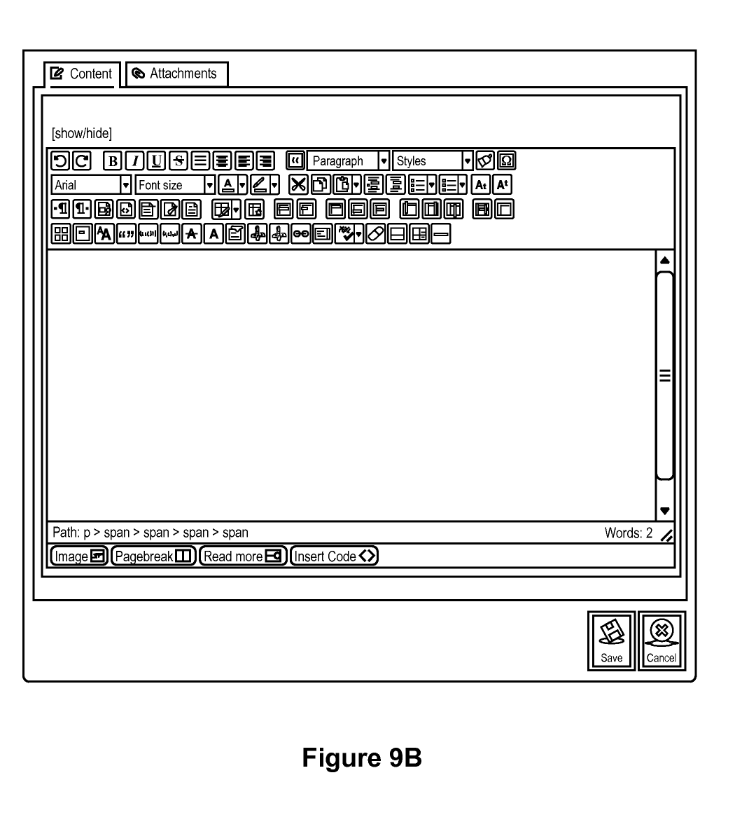

FIGS. 9A-9B Screen Shots of skillshadow.com Add Job Entry Page

FIGS. 9A and 9B particularly apply the invention to the field of employment. This is the Employer—Add Job Entry page for the skillshadow.com website. This is the parallel page to the Jobseeker's Add Profile page illustrated above in FIGS. 8A-8B. Employers may navigate around the website from this page (as further described under FIG. 5) and may once again select or change the language in which they would prefer to view the entire site or simply this page. The primary focus of this page is to allow an employer to create a job entry.

FIG. 9A illustrates that the user-friendly data collection of a Job Entry is (1) performed on a single input page and (2) consists entirely of pull-down menus for all required data attributes. Information collected on this page is used to perform the match with a different classification of user (i.e., with a jobseeker). An employer selects or inputs a title for this particular job entry. In some embodiments, the information collected also includes location (e.g., a selection of 271 countries, associated state or province, and city or geographical region), the industry and specific area of the industry (e.g., Science, Technology, Engineering and Mathematics is illustrated for the industry selection and Wind Energy Engineers is illustrated for the specific area selection), the position (e.g., full time, part time, temporary, or contract), experience required (e.g., none, 1 year, 2 years, 3-5 years, 6-10 years, 11-15 years, or above 15 years), the required education (e.g., none, high school or equivalent, military training, associates or vocational degree, bachelors degree, masters degree, doctorate, or professional), and the hourly pay offered (e.g. below $10/hour, $10-$15/hour, $15-$20/hour, $20-$30/hour, $30-$40/hour, or above $40/hour). The hourly pay is depicted in US dollars; however, a currency converter link is included to allow for conversion to the user's selected currency. More details regarding these selections are described with respect to FIG. 3.

In some embodiments, this webpage allows the employer to optionally include up to five (5) keyword attributes to limit the match responses (as more fully described under FIG. 3 above). Additionally, in some embodiments, the employer is permitted to include up to five hundred (500) characters of additional information the employer wishes other users to see.

As illustrated in FIG. 9B, the employer also has a second convenient input box in which to upload the employer's logo, the detailed job description, or other information. This input box provides for on-line input and/or attaching selected files, as more fully depicted and described for a Jobseeker in FIGS. 8A-8B.

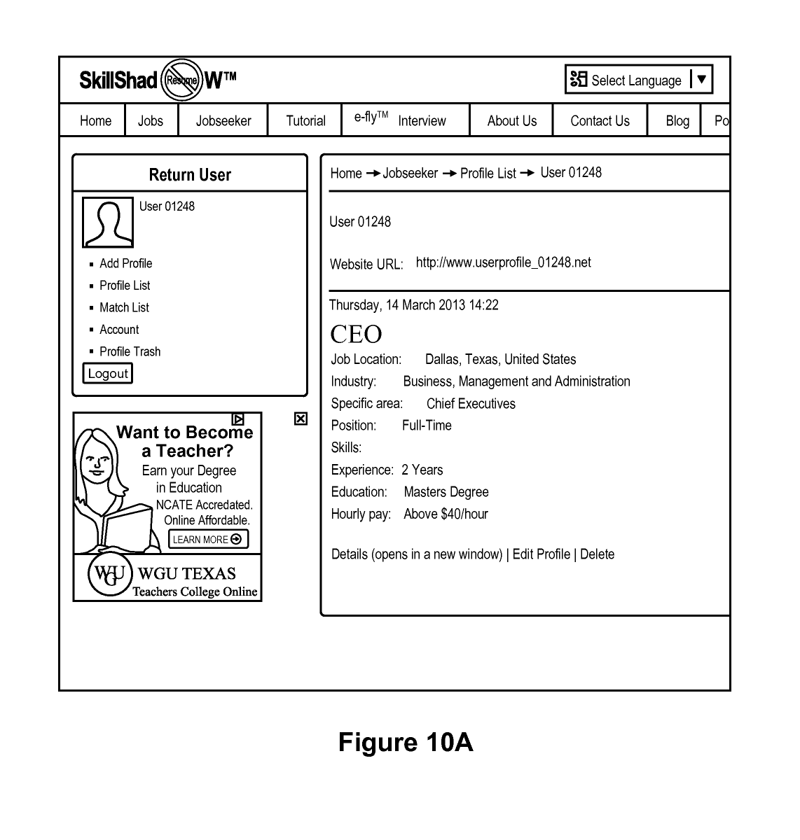

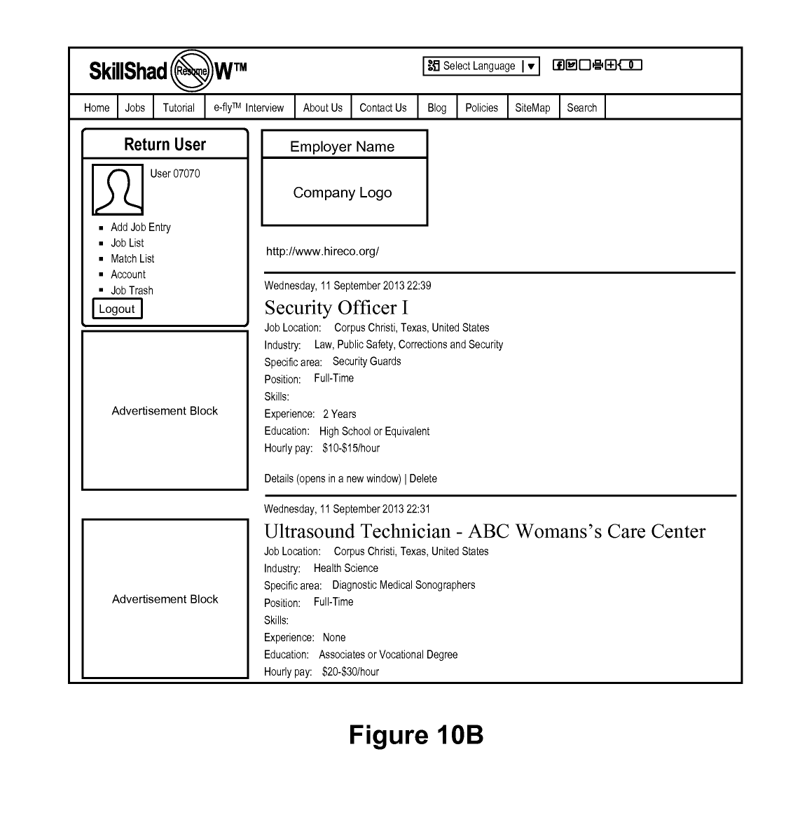

FIGS. 10A-10B Screen Shots of skillshadow.com Jobseeker—Profile List and Employer—Job List

FIGS. 10A-10B particularly apply the invention to the field of employment. FIG. 10A is a page listing all of the profiles created by a particular jobseeker on the skillshadow.com website. Jobseekers are permitted to create and save multiple simultaneously active profiles. Jobseekers may navigate around the website (as more fully described under FIG. 5) and navigate within the registered user options of Add Profile, Profile List, Match List, Account, and Profile Trash through the left hand menu, as previously described under FIGS. 8A-8B. In addition, Jobseekers may select the languages in which the jobseeker prefers to view and or save entries on this page or the entire site.

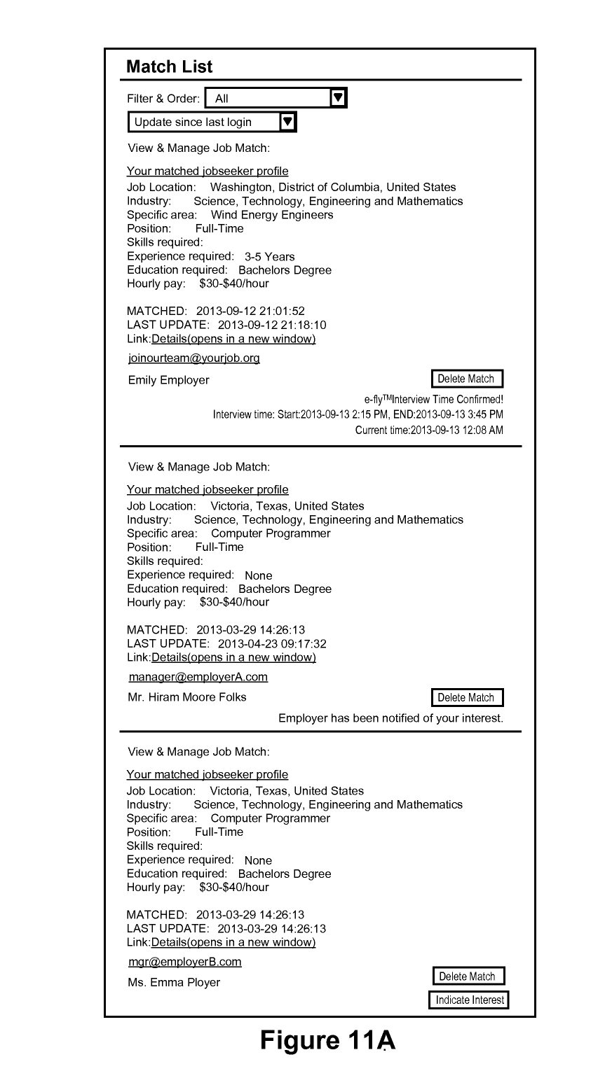

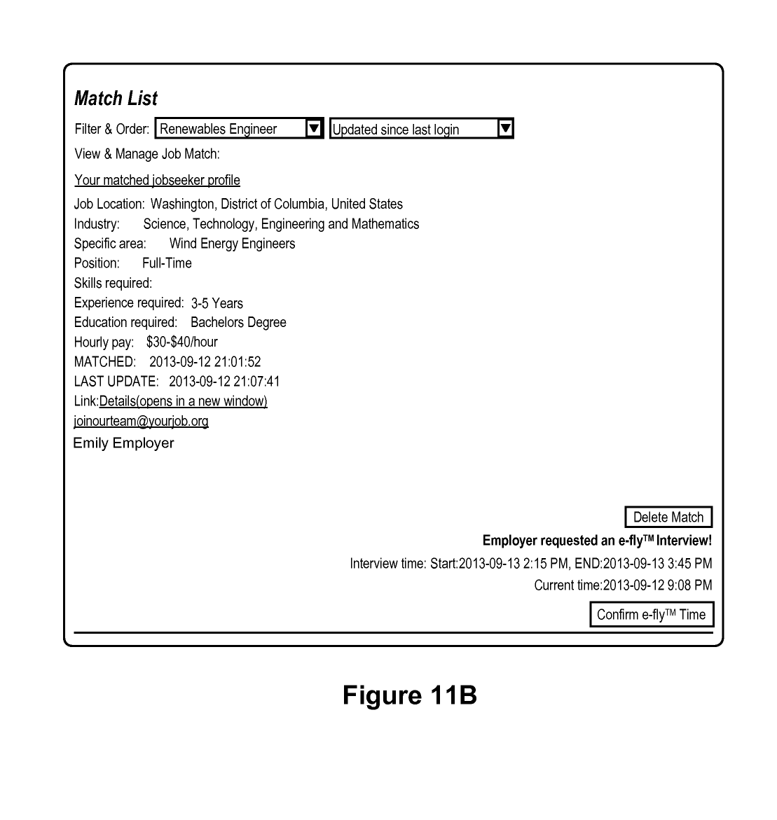

A jobseeker may have had a variety of previous job experience or may simply have an interest in a variety of jobs. The ability to create multiple profiles also permits a jobseeker to look for employment in multiple locations. This page is initially only available for the jobseeker's personal reference and is not viewable by other users. In some embodiments, this page is not viewable by similarly situated users (i.e., other registered jobseekers) with the exception of the case where the jobseeker chooses to provide access to the jobseeker's profile(s) via social sharing. Once a jobseeker has clicked the Indicate Interest button on the jobseeker's Match List in response to a matched position (See FIG. 11A), the user matched in the other classification (the matched employer) will have access to this page to view details of the jobseeker's profile(s).

Each profile summary displayed on the jobseeker's Profile List page is clickable as is the “Details (opens in a new window)” link under each profile. Either link from this page leads to the jobseeker's full detailed input for each profile. Each profile may be edited as often as desired. The comprehensive summary information presented on this Profile List page includes all location components, industry, specific area, position, all optional keywords and text input, the jobseeker's experience, education, pay requested for each unique profile, and any attachments.

FIG. 10B is the Employer—Job List page for the skillshadow.com website. This page, which is the employer's landing page after successfully logging in, allows the employer to navigate throughout the password-protected employer portions of the website as illustrated in the left column of FIG. 10B. The primary purpose is to display summary information for the employer's job entries on a single page for management, including deletion or launch of the detailed view for editing.

FIGS. 11A-11B Screen Shots of Jobseeker—Match List Page

FIGS. 11A-11B particularly apply the invention to the field of employment. The primary purposes of the match list is to (1) alert the Jobseeker to matched profiles and allow them to view the details, and (2) permit the Jobseeker to respond, such as Indicate Interest, Confirm E-Fly™ Interview, or Delete Match. In contrast to the jobseeker's Profile List page (FIG. 10A) which displays summaries of the jobseeker's totality of profile inputs, a jobseeker's Match List page will show the position requirements input by the other classification of user (the employer) with which the jobseeker was matched. That is, the jobseeker's Match List will show to the jobseeker the pay offered by the employer rather than the pay requested by the jobseeker.

FIG. 11A illustrates matches in all the various stages. The third match (at the bottom of FIG. 11A) illustrates a new match awaiting the Jobseeker's review. The match thus displays buttons for the choices available to the jobseeker for such match (i.e., Indicate Interest or Delete Match).

The middle match (center of FIG. 11A) shows the message the system provides once the jobseeker has indicated interest in a position and the employer has been notified. In some embodiments, this is an indication that the other classification of user (e.g., the employer) has been provided with the contact and personal profile information input by the user (Jobseeker).

The match depicted in FIG. 11B illustrates that the employer has requested a web-based (E-Fly™) interview with the jobseeker. In this instance the employer has requested 2:15 pm to 3:45 pm on Sep. 13, 2013. The employer's contact details (including an e-mail link) are provided and a link to the full detailed job description. The jobseeker may contact the employer to reschedule or simply click once to “Confirm E-Fly™ Time”. As elaborated under FIG. 3, the jobseeker would have received e-mail alert to the web-based interview request.

The match illustrated at the top of FIG. 11A depicts the jobseeker's confirmation of the web-based interview requested in FIG. 11B.

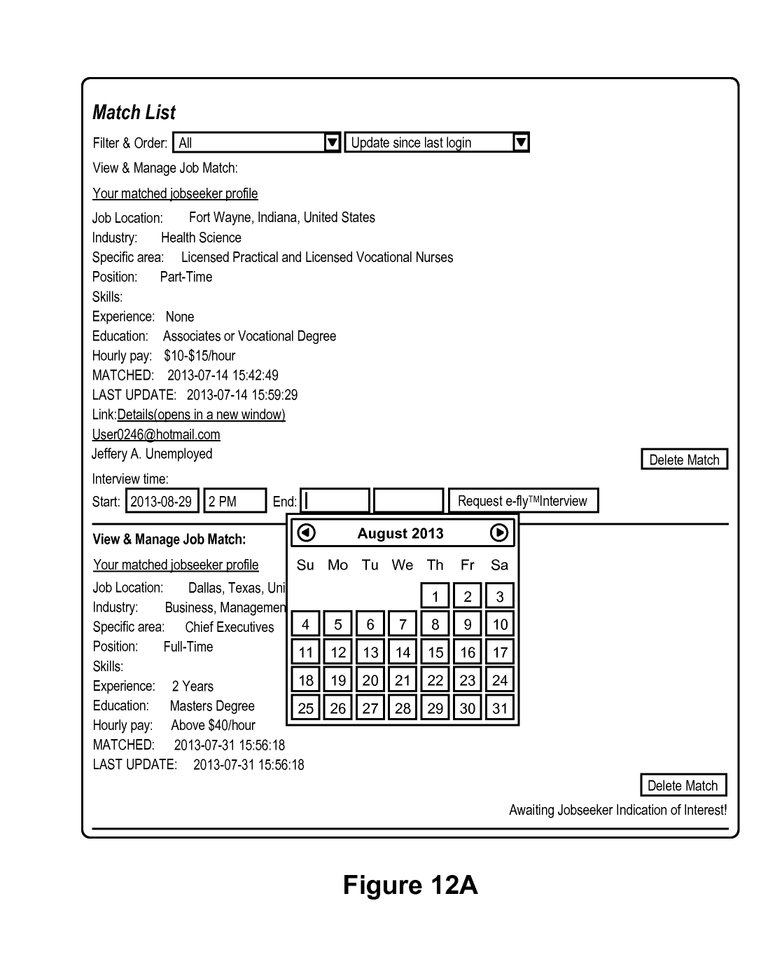

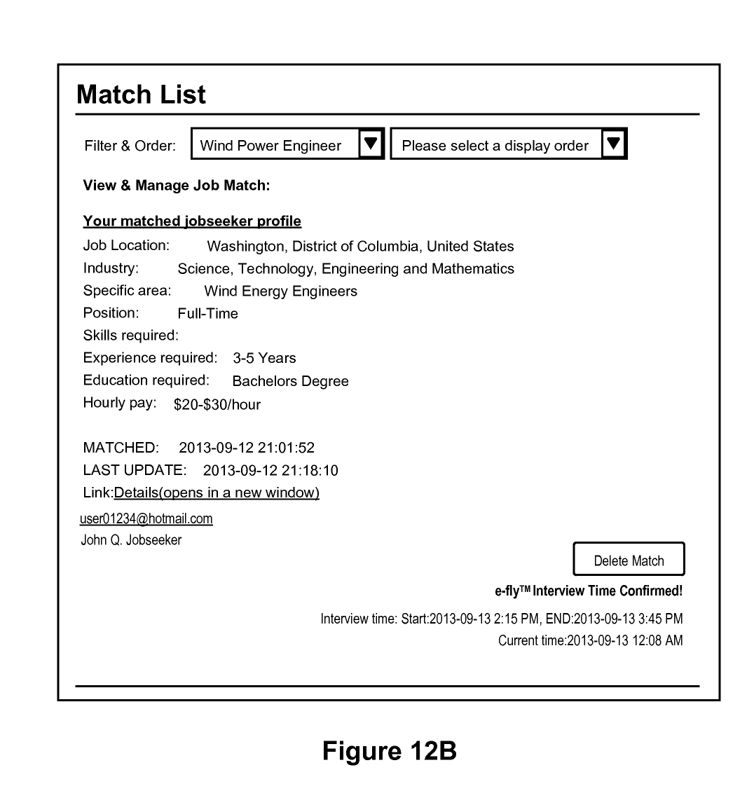

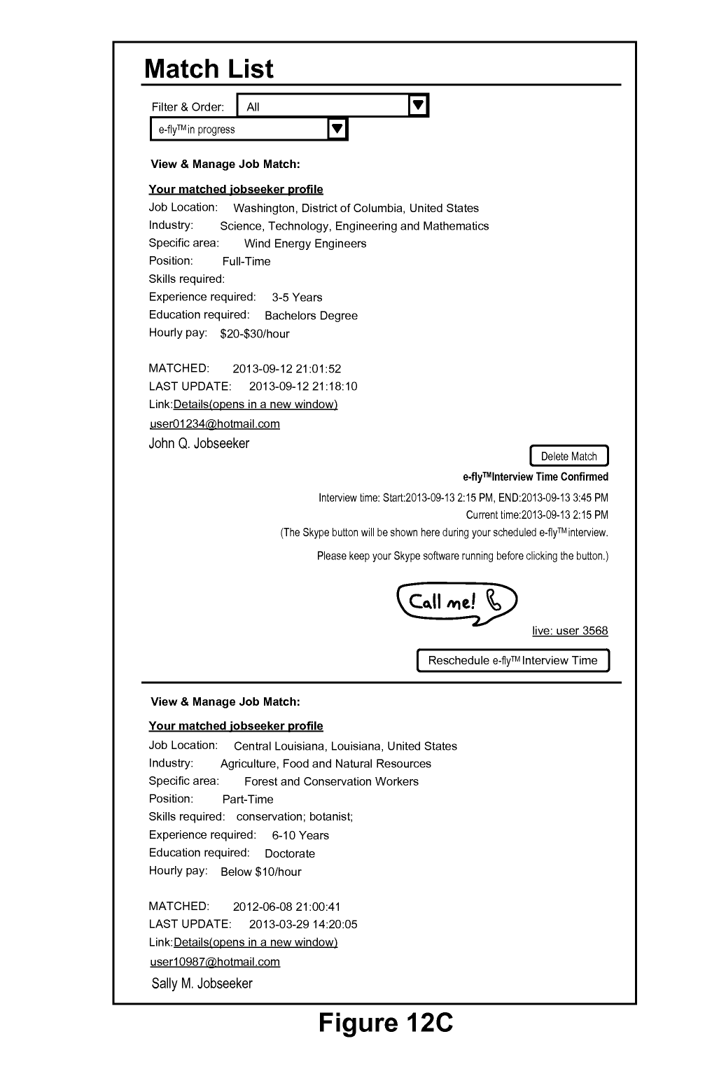

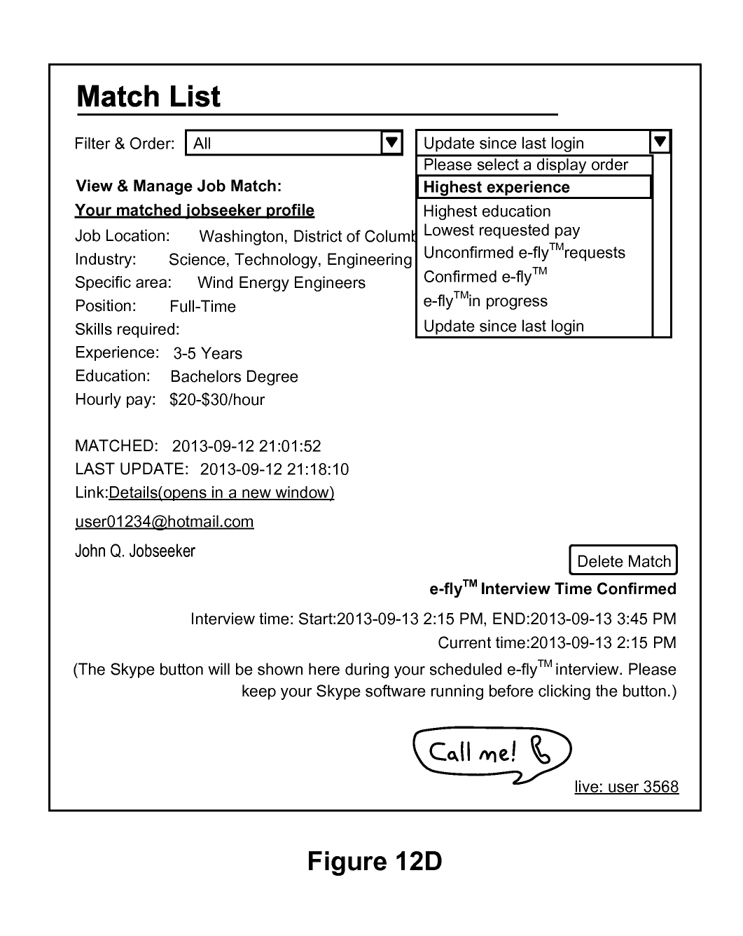

FIGS. 12A-12D Screen Shots of Employer—Match List Page

FIGS. 12A-12D particularly apply the invention to the field of employment. The Match List page for a particular employer on the skillshadow.com website is accessible through the left hand column navigation links for a registered employer (as illustrated in FIG. 10B). The Match List (for both employers and jobseekers) represents the crux of the matching system functionality of skillshadow.com.

All positions on an employer's job list which have been matched to potential jobseekers will appear in a list on this page. FIG. 12C illustrates a truncated view of the employer's matches.

FIG. 12B illustrates the results of the employer utilizing the sorting tools available in some embodiments. In FIG. 12B, the employer has sorted by the job title “Wind Power Engineer” and displays only results of matches for that position. In some embodiments, all positions input by an Employer (and conversely, all Profiles input by a Jobseeker) are accessible in a “Filter” pull-down menu at the top of the Match List page. By selecting a particular title, only match results for that title will be displayed.

These matches may then be further ranked by the addition of the “Order” pull-down menu in FIG. 12D. The “Filter” and “Order” tools may be used in conjunction with each other or independently. For example, an employer may search their Match List for confirmed web-based (E-Fly™) interviews across all open positions or by a particular position title only. In some embodiments, additional prioritization tools are employed, such as time-stamping of the other classification of user's response. In other embodiments, other prioritization tools (and combinations thereof) are provided and performed by the system to best suit the users' Match List management.

Additionally (in addition to or separate from the job title sort function), candidates may be prioritized based upon highest education, highest experience, or lowest requested pay. In some embodiments, the candidates are first ordered according to a weighted combination of criteria automatically provided by the system, but the employer then has the option of explicitly ordering by one criterion as illustrated in FIG. 12D. (One exemplary weighted combination provided by the system includes a weighted combination of highest education, highest experience, and lowest requested pay: giving highest experience twice the weight of education and lowest pay three quarters the weight of education).

An employer may elect to view updates since their last login. In some embodiments, the employer is provided the jobseeker's name and contact e-mail in the Employer's Match List and may view the jobseeker's full profile(s) through a link, only after the jobseeker has indicated interest in the employer's position. This privacy condition is more fully described in FIG. 3, step 3. Note that jobseekers have similar Match List pages (FIGS. 11A-11B) which provide them with the opportunity to preview matched positions before indicating interest and revealing their identity. As illustrated in FIG. 12A, a matched candidate has indicated interest; therefore, the employer's Match List automatically depicts a web-based interview scheduling tool.

In some embodiments, under the applicable interested jobseeker's match, the employer is provided a pop-up calendar for ease of requesting a web-based interview. By simply selecting start and end times from the pop-ups and clicking the “Request E-Fly™ Interview” button (as shown in FIG. 12A), the employer's web-based interview request will be conveyed to the Jobseeker. Once an employer has clicked the Request E-Fly™ Interview button, the system generates an e-mail alert to the jobseeker and the request simultaneously appears in the jobseeker's Match List as illustrated in FIG. 11B. The employer's Match List will immediately display the requested E-Fly™ Interview time slot and a bold notice that the E-Fly™ Interview is “Awaiting Jobseeker's Confirmation.” As depicted in FIG. 12A, the functionality to schedule an E-Fly™ interview is automatically included under every interested individual in the matched candidate listing for that position.

FIG. 12B follows on from FIG. 12A to depict how the Employer's Match List might appear following the jobseeker's acceptance/confirmation of the requested interview time. In some embodiments, as depicted in FIG. 12B, at the instant the jobseeker confirms the time through the jobseeker's Match List (see FIG. 11B), the employer's Match List will be updated to indicate “E-Fly™ Interview Time Confirmed!” E-mail communication will be sent to both parties to alert them to the confirmed interview time slot. More details regarding scheduling a web-based interview are described with respect to FIG. 3, step 5.

As illustrated in FIG. 12C or FIG. 12D, when the E-Fly™ web-based interview time arrives, the employer will be shown a “Call Me” button for a peer-to-peer live video chat web-based interview (such as Skype or the like) under the appropriate match on the Match List page. The employer simply clicks the button to initiate the E-Fly™ web-based interview.

FIG. 12C illustrates how in some embodiments the “Call Me” button will appear in the Employer's Match List once the web-based interview time has arrived, as more fully described in FIG. 3. In some embodiments, there are no limits on the number of E-Fly™ web-based interviews an employer may schedule and no limitations on the duration of an employer's web-based E-Fly™ interview. Also, in some embodiments, an employer may reschedule interviews as many times as necessary with functionality provided in the Match List. Employers (and jobseekers) may also keep the Match List tidy by clicking the “Delete Match” button under any matches the employer (or jobseeker) does not wish to pursue. In some embodiments, deleting a job entry (in the case where a position has been filled), deletes all associated matches. In some embodiments, deleted job entries of employers and deleted profiles of jobseekers may be restored through the “job trash” or “profile trash” restoration functionality, respectively.

In contrast to the employer's Job List page (FIG. 10B, which displays summaries of the job position attributes as input by the employer), the employer's Match List page displays summaries of the data attributes as input by the other classification of user (i.e., the jobseeker). The Match List page shows the registered employer all matches individually received for each of the positions the employer has entered. Matches display all location parameters, plus industry, specific area, and position attributes input by the employer. Following that, the Match List displays the keywords, experience, education, and desired pay as input by the other classification of user, the matched jobseeker (i.e., the employer's Match List will display to the employer the pay requested by the matched jobseeker rather than the pay offered by the employer). In some embodiments, the Match List further displays both the original time the employer posted the position and the time at which a particular match was received or other update occurred.

The counterpart to FIGS. 12A-D for the other classification of user is the jobseeker's Match List which displays the employer's requirements, as illustrated in FIGS. 11A-11B. In particular, it can be illustrated in the top match FIG. 11A (the Jobseeker's Match List) that the employer is offering $30-40/hour, while in FIG. 12D (the Employer's Match List) that the jobseeker is requesting $20-30/hour. This is an example of a covered match, as more fully described under FIG. 3.

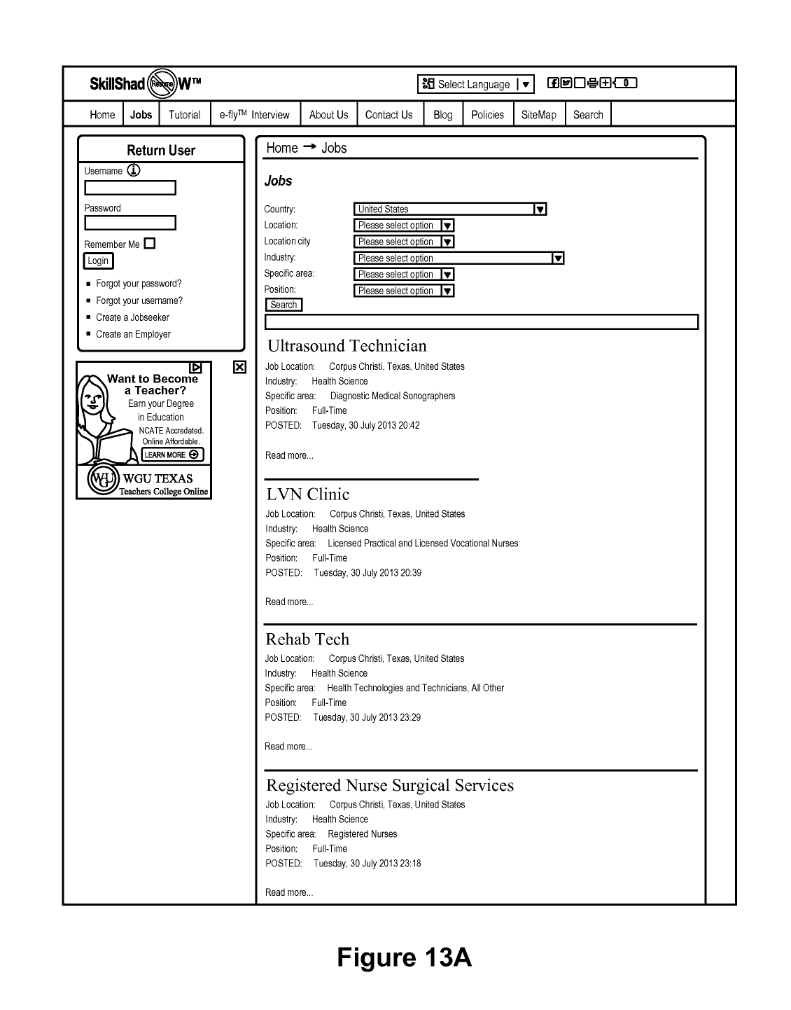

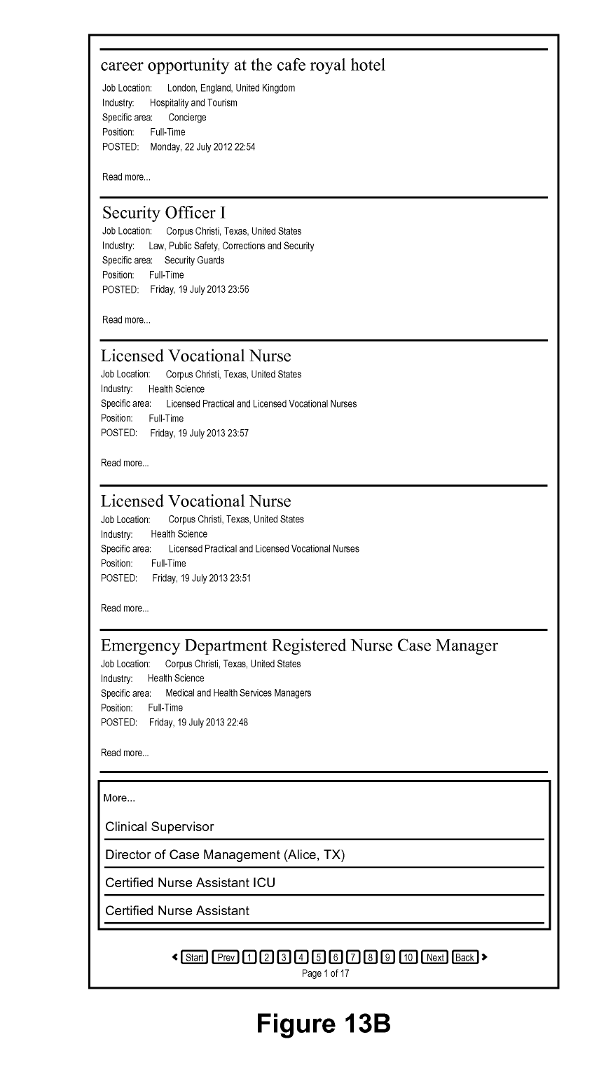

FIGS. 13A-13B Screen Shot of skillshadow.com Jobs Page

FIGS. 13A-13B particularly apply the invention to the field of employment. These are illustrations of the Jobs page for the skillshadow.com website which includes a plurality of job listings. The Jobs page is accessible by both registered and unregistered users. A user may select the language in which they prefer to view the listing of jobs.

All job entries input on skillshadow.com are displayed on the general Jobs page. Enough information is displayed with each position (location parameters, industry, specific area, position, and keywords for any specific skills required) to help users scan for positions of interest. Whether registered or not, a user may search through the available positions and click on any position of interest to see the full position details.

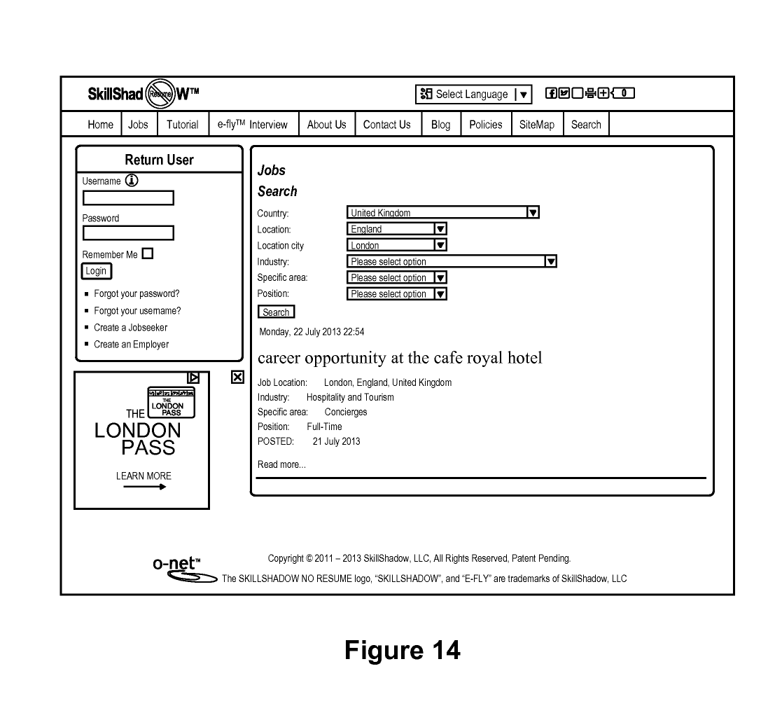

FIG. 14 Screen Shot of skillshadow.com Jobs Search Results Page

FIG. 14 particularly applies the invention to the field of employment. The skillshadow.com website includes a search bar tool (visible in FIGS. 13A and 14) which enables a user to sort and display a desired subset of all Jobs. In some embodiments, the user may specify any number of attributes including: country, location, industry, specific area, and/or position prior to clicking “Search”. The search may include or exclude one or more selections in each category in a wide array of combinations (e.g., a user may select no location and no position, while performing a search on an industry and specific area only). The results of such a search are illustrated in FIG. 14.

When a Job is clicked, the details appear (experience and education required, and hourly pay offered) as well as further clickable links to view other job entries from this particular employer contact.

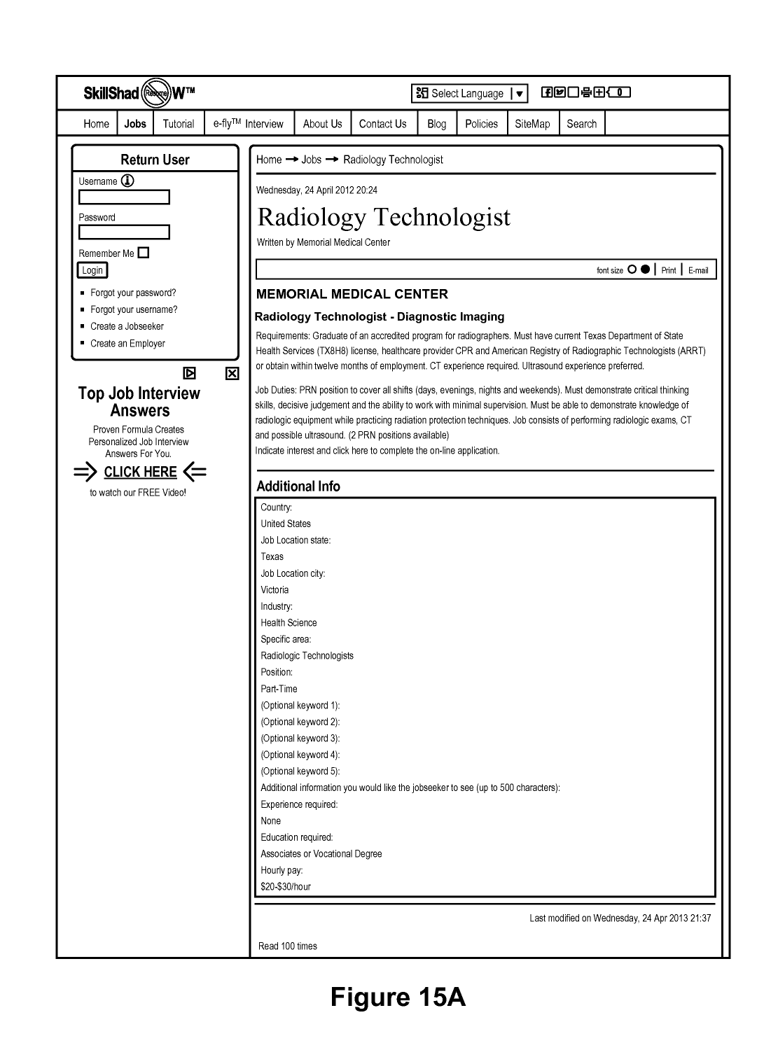

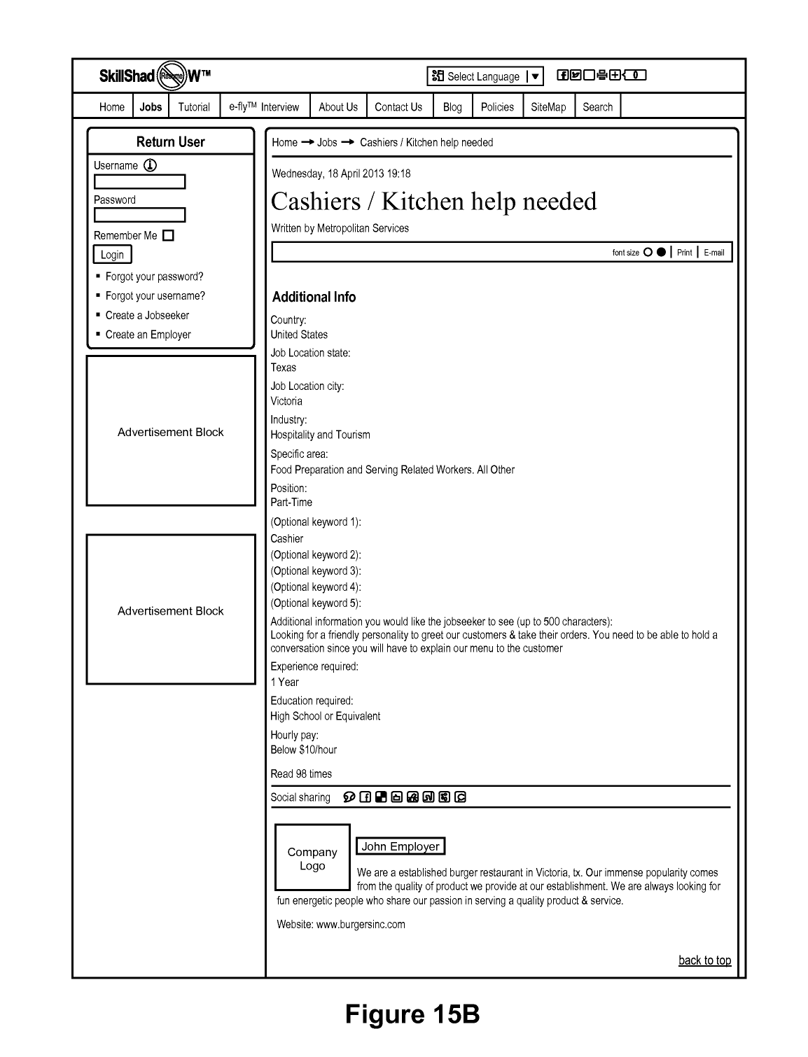

FIGS. 15A-15B Screen Shots of skillshadow.com Jobs Detail Page

FIGS. 15A-15B particularly apply the invention to the field of employment. FIG. 15B is an alternate view of FIG. 15A. These pages depict the details of job entries accessed by clicking either a specific job title or a “Read more . . . ” link on the Jobs page for the skillshadow.com website (FIGS. 13A-13B). These pages are accessible by both registered and unregistered users. A user may select the language in which they prefer to view the detailed job entries.

All job entries input on skillshadow.com are displayed in summary form on the Jobs page (as described under FIGS. 13A-13B). Through links, the details of each job entry are accessible by all users. Whether registered or not, a user may search through the Jobs and click on any position of interest to see the full position details depicted on this page. The details of experience required, education required, and hourly pay offered are shown on the Jobs Detail page, as illustrated in FIG. 15A or alternately FIG. 15B. The Job Detail page also displays additional clarifying information input by the employer (e.g., night shift) and links to any attachments or additional input. In some embodiments, this job detail page includes links for social sharing of this position and includes further clickable links to view all other available job positions of this particular employer.

FIGS. 15A and 15B illustrate that, in some embodiments, users in one classification (employers) may present their requirements (job entries) in their own unique styles without compromising the ability of the system to perform the matching function.

In some embodiments, the Jobs Detail Page (and other pages on the website) will include advertisements. The advertisements may be presented in a top or bottom banner, a side bar or the like. In some embodiments, the advertisements are relevant to the content of the presented page. For instance, keywords found within the page may trigger the provision of an appropriate advertisement. In other embodiments, the advertisement is not actively matched to the content of the presented webpage.

The present invention as particularly applied to the field of employment was developed using open source software, with LINUX operating system, Apache HTTP server, PHP programming language and MySQL database software. Joomla 1.5 is the content management framework (CMF), which allows the front end user interface design to be separated from the back end functionality. The user management is based on K2, which is an extension of Joomla. The K2 extension was deeply customized to create the input screens for employers and jobseekers which comprise the capture part of the present invention.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method for matching profiles without a resume, the method comprising:
comparing a plurality of attributes associated with an initiator with a plurality of requirements associated with a respondent to generate a notification of a match-event;
providing a bi-directional notification of the match-event to the initiator and the respondent;
providing a bi-directional confirmation of a web-based interview between the initiator and the respondent, including providing a finalized set of scheduling information for the web-based interview; and
in accordance with a determination that a current date and a current time match the finalized set of scheduling information, initiating the web-based interview between the initiator and the respondent including providing a capability for web-based video conferencing between the initiator and the respondent.

2. The method of claim 1, further including, prior to comparing the plurality of attributes with the plurality of requirements:
obtaining the plurality of attributes associated with the initiator; and
obtaining the plurality of requirements associated with the respondent.

3. The method of claim 1, wherein providing the bi-directional notification of the match-event and the bi-directional confirmation of the web-based interview includes:
sending to the initiator the notification of the match-event and in response, receiving from the initiator an approval to transmit a set of one or more of the attributes associated with the initiator to the respondent;
transmitting the set of one or more of the attributes to the respondent and in response, receiving from the respondent a request for the web-based interview with the initiator, including one or more sets of scheduling information and electronic contact information;
transmitting to the initiator the request for the web-based interview and in response, receiving from the initiator a confirmation of the web-based interview and the finalized set of scheduling information selected from the one or more sets of scheduling information; and
transmitting to the respondent the finalized set of scheduling information.

4. The method of claim 1, wherein generating the notification of the match-event includes:
generating an index of likeness between the initiator and the respondent based on the comparison of the plurality of attributes associated with the initiator with the plurality of requirements associated with the respondent; and
in accordance with a determination that the generated index of likeness is greater than a predefined threshold, generating the notification of the match-event.

5. The method of claim 1, wherein generating the notification of the match-event further includes prioritizing match-events associated with a plurality of initiators.

6. The method of claim 1, wherein generating the notification of the match-event further includes comparing a profile-creation time-stamp associated with the initiator with a plurality of profile-creation time-stamps associated with a plurality of contending initiators.

7. The method of claim 1, wherein generating the notification of the match-event further includes comparing a bi-directional confirmation time-stamp associated with the initiator with a plurality of bi-directional confirmation time-stamps associated with a plurality of contending initiators.

8. The method of claim 1, further including prior to receiving from the respondent the request for the web-based interview, receiving from the initiator permission to transmit to the respondent contact information for the initiator not previously provided to the respondent.

9. The method of claim 1, further including prior to receiving from the respondent the request for the web-based interview, receiving from the respondent a request for contact information for the initiator not previously provided to the respondent.

10. The method of claim 1, further including, after initiating the web-based interview, providing to the respondent contact information for the initiator not previously provided to the respondent.

11. The method of claim 1, wherein the plurality of attributes associated with the initiator is selected from the group consisting of: first geographical information, a first industry, a first skill-set, a first job position, a first level of experience, first educational information, first compensation information, and first keyword information.

12. The method of claim 11, further including:
providing a user-selectable menu of currencies;
detecting a selection of a first currency from the user-selectable menu of currencies; and
displaying the first compensation information in accordance with the first currency selected.

13. The method of claim 1, further including:
providing a user-selectable menu of languages;
detecting a selection of a first language from the user-selectable menu of languages; and
storing and displaying the plurality of attributes in accordance with the first language selected.

14. The method of claim 1, wherein the plurality of requirements associated with the respondent is selected from the group consisting of: identification information associated with the respondent, second geographical information, a second industry, a second skill-set, a second job position, a second level of experience, second educational information, second compensation information, and second keyword information.

15. The method of claim 14, further including:
providing a user-selectable menu of currencies;
detecting a selection of a second currency from the user-selectable menu of currencies; and
displaying the second compensation information in accordance with the second currency selected.

16. The method of claim 1, wherein the plurality of attributes associated with the initiator includes one or more file attachments selected from the group consisting of: a resume, a cover letter, a representation of a website, and an electronic portfolio.

17. The method of claim 1, wherein the plurality of attributes associated with the respondent includes one or more file attachments selected from the group consisting of: a job description, benefits information, a company logo, and a representation of a website.

18. The method of claim 1, further including providing a link configured to cause an external service to display the plurality of attributes associated with the initiator to other users of the external service.

19. The method of claim 1, further including providing a link configured to cause an external service to display the plurality of requirements associated with the respondent to other users of the external service.

20. The method of claim 1, further including generating a plurality of profiles associated with the initiator, wherein each profile associated with the initiator is characterized by a distinct combination of one or more attributes associated with the initiator.

21. A system, for matching profiles without a resume, comprising:
one or more processors; and
memory storing one or more programs to be executed by the at least one processor;
the one or more programs comprising instructions for:
comparing a plurality of attributes associated with an initiator with a plurality of requirements associated with a respondent to generate a notification of a match-event;
providing a bi-directional notification of the match-event to the initiator and the respondent;
providing a bi-directional confirmation of a web-based interview between the initiator and the respondent, including providing a finalized set of scheduling information for the web-based interview; and
in accordance with a determination that a current date and a current time match the finalized set of scheduling information, initiating the web-based interview between the initiator and the respondent including providing a capability for web-based video conferencing between the initiator and the respondent.

22. A non-transitory computer readable storage medium storing one or more programs configured for execution by a computer, the one or more programs comprising instructions for:
comparing a plurality of attributes associated with an initiator with a plurality of requirements associated with a respondent to generate a notification of a match-event;
providing a bi-directional notification of the match-event to the initiator and the respondent;
providing a bi-directional confirmation of a web-based interview between the initiator and the respondent, including providing a finalized set of scheduling information for the web-based interview; and
in accordance with a determination that a current date and a current time match the finalized set of scheduling information, initiating the web-based interview between the initiator and the respondent including providing a capability for web-based video conferencing between the initiator and the respondent.
